(19) United States
(12) Patent Application Publication
(10) Pub. No.: US 2026/0057748 A1
(43) Pub. Date: Feb. 26, 2026

(54) ELECTRONIC GAMING SYSTEM AND METHOD HAVING A COMMUNITY GAME PLAY DISPLAY AREA

(71) Applicant: Aristocrat Technologies, Inc., Las Vegas, NV (US)

(72) Inventors: Shayer Shaik, Palam Vihar (IN); Nathan Warms, Austin, TX (US)

(21) Appl. No.: 18/897,990

(22) Filed: Sep. 26, 2024

Related U.S. Application Data
(60) Provisional application No. 63/685,061, filed on Aug. 20, 2024.

(51) Int. Cl. G07F 17/34

(52) U.S. Cl. CPC G07F 17/34

(57) ABSTRACT

An electronic gaming device for providing a community-based electronic game including a community matrix for providing community gameplay of the community-based electronic game. The community-based electronic game includes a base game including a first set of reels and the community matrix displayed within a display interface of the community-based electronic game. One or more social trigger symbols associated with play of the base game by a plurality of players are randomly determined and presented on one or more reel columns of the first set of reels. For each of the one or more social trigger symbols, one or more community social trigger symbols are presented on one or more columns of the community matrix, each of the one or more community social trigger symbols being attributed to respective one or more players of the plurality of players of the base game associated with at least one social trigger symbol.

### CROSS-REFERENCE TO RELATED APPLICATIONS

This application claims the benefit of priority of U.S. Provisional Application No. 63/685,061, filed Aug. 20, 2024, titled “ELECTRONIC GAMING SYSTEM AND METHOD HAVING A COMMUNITY GAME PLAY DISPLAY AREA,” the contents and disclosures of which are hereby incorporated herein by reference in their entirety.

### TECHNICAL FIELD

The field of disclosure relates generally to electronic gaming, and more specifically, to electronic gaming systems and methods that include displaying a community game play display area including a community matrix during gameplay wherein the community game play display area provides community gameplay amongst players of the game.

### BACKGROUND

Electronic gaming machines (“EGMs”) or electronic gaming devices provide a variety of wagering games such as slot games, video poker games, video blackjack games, roulette games, video bingo games, keno games and other types of games that are frequently offered at casinos and other locations. Play on EGMs and/or electronic gaming devices typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one embodiment, an electronic gaming device for providing a community-based electronic game including a community matrix for providing community gameplay of the community-based electronic game. The electronic gaming device includes at least one memory device with instructions stored thereon and at least one processor in communication with the at least one memory device. The instructions, when executed by the at least one processor, cause the at least one processor to: (i) generate and display, as part of a base game of the community-based electronic game, a first set of reels and the community matrix within a display interface of the community-based electronic game; (ii) randomly determine one or more social trigger symbols to be presented on one or more reel columns of the first set of reels, the one or more social trigger symbols being associated with a plurality of players of the community-based electronic game playing in a same session of the community-based electronic game as one another; and (iii) for each of the one or more social trigger symbols presented on the one or more reel columns of the first set of reels, simultaneously cause one or more community social trigger symbols to be presented on one or more columns of the community matrix, each of the one or more columns of the community matrix aligning with and being associated with a corresponding respective reel column of the one or more columns of the first set of reels, and each of the one or more community social trigger symbols being attributed to respective one or more players of the plurality of players whose play in the base game resulted in at least one social trigger symbol of the one or more social trigger symbols to be presented on the one or more columns of the first set of reels.

In another embodiment, a computer-implemented method for providing a community-based electronic game implemented using at least one processor in communication with at least one memory, the method including: (i) generating and displaying, as part of a base game of the community-based electronic game, a first set of reels and a community matrix within a display interface of the community-based electronic game; (ii) randomly determining one or more social trigger symbols to be presented on one or more reel columns of the first set of reels, the one or more social trigger symbols being associated with a plurality of players of the community-based electronic game playing in a same session of the community-based electronic game as one another; and (iii) for each of the one or more social trigger symbols presented on the one or more reel columns of the first set of reels, simultaneously causing one or more community social trigger symbols to be presented on one or more columns of the community matrix, each of the one or more columns of the community matrix aligning with and being associated with a corresponding respective reel column of the one or more columns of the first set of reels, and each of the one or more community social trigger symbols being attributed to respective one or more players of the plurality of players whose play in the base game resulted in at least one social trigger symbol of the one or more social trigger symbols to be presented on the one or more columns of the first set of reels.

In yet another embodiment, one or more non-transitory computer-readable storage media with instructions stored thereon that, in response to being executed, cause an electronic gaming device to: (i) generate and display, as part of a base game of a community-based electronic game, a first set of reels and a community matrix within a display interface of the community-based electronic game; (ii) randomly determine one or more social trigger symbols to be presented on one or more reel columns of the first set of reels, the one or more social trigger symbols being associated with a plurality of players of the community-based electronic game playing in a same session of the community-based electronic game as one another; and (iii) for each of the one or more social trigger symbols presented on the one or more reel columns of the first set of reels, simultaneously cause one or more community social trigger symbols to be presented on one or more columns of the community matrix, each of the one or more columns of the community matrix aligning with and being associated with a corresponding respective reel column of the one or more columns of the first set of reels, and each of the one or more community social trigger symbols being attributed to respective one or more players of the plurality of players whose play in the base game resulted in at least one social trigger symbol of the one or more social trigger symbols to be presented on the one or more columns of the first set of reels.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts an exemplary gameplay interface according to an embodiment of the present disclosure, including (i) a base game interface portion including a reel set showing various symbols having landed thereon, (ii) a community matrix, and (iii) a wheel.

FIG. 5A depicts an exemplary gameplay interface according to an embodiment of the present disclosure, namely a boost symbol interface in accordance with the interface shown in FIG. 4.

FIG. 5B depicts an exemplary gameplay interface according to an embodiment of the present disclosure, namely a boost gameplay interface, in accordance with the interface shown in FIGS. 4 and 5A.

FIG. 6 depicts an exemplary gameplay interface according to an embodiment of the present disclosure, namely populating the community matrix with a community social trigger symbol in response to a social trigger symbol that landed on the base game reel set, in accordance with the interface shown in FIG. 4.

FIG. 7 depicts an exemplary gameplay interface according to an embodiment of the present disclosure, namely population of the community matrix with community social trigger symbols, in accordance with the interface shown in FIG. 4.

FIG. 8 depicts an exemplary gameplay interface element according to an embodiment of the present disclosure, namely a multiplier wheel.

FIG. 9 depicts an example gameplay interface of a bonus game of the base game according to an embodiment of the present disclosure.

FIG. 10 illustrates an example embodiment of an introduction/loading interface for entry into an example electronic (e.g., mobile) game embodying the gameplay interfaces and interface elements according to the embodiments of FIGS. 4-9.

FIG. 11A illustrates an example interface of a base game of the mobile game, including a reel set of the base game and a community board, in accordance with the mobile game shown in FIG. 10.

FIG. 11B illustrates an example embodiment of community play of the mobile game shown in FIG. 11A by a plurality of players via respective end user devices of the players.

FIG. 12 illustrates an example landing interface of various COR symbols on a reel set in accordance with the interface shown in FIG. 11A.

FIG. 13 illustrates example visual graphics that may appear during play of the base game in accordance with the interface shown in FIG. 11A.

FIG. 14A illustrates an example landing interface of a boost symbol on a reel set in accordance with the interface shown in FIG. 11A.

FIG. 14B illustrates an example interface of a boost function where the boost symbol boosts a normal trigger symbol on the reel set in accordance with the interface shown in FIGS. 11A and 14A.

FIG. 14C illustrates an example result interface of the boost function, namely boosting the normal trigger symbol to a social trigger symbol.

FIG. 15A illustrates an example interface of a triggering of a bonus game of the base game, in accordance with the mobile game shown in FIG. 10.

FIG. 15B illustrates an example interface of awarding a bonus of the bonus game, in accordance with the mobile game shown in FIG. 10 and the interface shown in FIG. 15A.

FIG. 15C illustrates an example award interface of an award of the bonus game, in accordance with the mobile game shown in FIG. 10 and the interface shown in FIGS. 15A and 15B.

FIG. 16A illustrates an example triggering interface of a feature game from the base game, in accordance with the mobile game shown in FIG. 10 and the interfaces shown in FIGS. 11A-14C.

FIG. 16B illustrates an example feature game introduction interface in accordance with the mobile game shown in FIG. 10.

FIG. 16C illustrates an example game play interface of the feature game in accordance with the mobile game shown in FIG. 10 and the feature game shown in FIG. 16B.

FIG. 16D illustrates an example prize interface after wins in the feature game, in accordance with the mobile game shown in FIG. 10 and the feature game shown in FIGS. 16B and 16C.

FIG. 16E illustrates an example prize interface upon conclusion of the feature game, in accordance with the mobile game shown in FIG. 10 and the feature game shown in FIGS. 16B-16D.

FIG. 17 illustrates an example configuration of end user devices that players may use to play the electronic game shown in FIGS. 10-13, 14A-14C, 15A-15C, and 16A-16E.

FIG. 18 illustrates an example method for providing the electronic game shown in FIGS. 10-13, 14A-14C, 15A-15C, and 16A-16E.

### DETAILED DESCRIPTION

Described herein are electronic gaming systems and methods that leverage social play functions in a gaming application to create a new social mechanic which drives increased social action amongst players.

The gaming application may be configured as a game to be played on an end user device such as a personal computing device including the likes of tablets and/or smartphones. A standard reel set may be provided along with a community board adjacent to the standard reel set. The community board is similar to the standard reel set in that it has rows and columns for symbols, however, the symbols in the community board may not land on the community board in the same manner as symbols would land on the standard reel set. Rather, the populating of symbols on the community board may be linked to the landing of certain symbols in the standard reel set as described herein.

The amount of rows and columns of the community board may match those of a standard reel set. In some embodiments, the community board may be stacked above and aligned with the standard reel set. During play of the game, landing a certain trigger symbol on a column of the standard reel set may cause a corresponding symbol to be deposited in a corresponding column of the community board. The corresponding symbol in the community board column may include a profile picture or other avatar of the player that landed the trigger symbol on the standard reel set that caused the corresponding symbol to be deposited in the column of the community board. As such, players in the game can see which players have contributed to the social board, which may build excitement and drive engagement. The columns of the community board may be visually aligned with the columns of the standard reel set to further emphasize and display the connection between the landing of certain symbols on the standard reel set with the triggering of the populating of corresponding symbols in columns of the community board.

When a column of the community board is filled with a pre-determined amount of symbols, a bonus game may be triggered. The players that contributed symbols to the community board may all partake in the bonus game and win a corresponding prize resulting from the bonus game. The bonus game may utilize the community board as part of the bonus game, and specifically may utilize any given full column of the community board as part of the bonus game. This also increases excitement and drives engagement amongst players, especially between the players that triggered the bonus game by the contribution to the community board. In some embodiments, the bonus game may be a wheel-based bonus game where a wheel with a plurality of multiplier values on it spins, and the multiplier value (e.g., 3×, 5×, etc.) that lands after the wheel stops may increase an amount associated with the symbols in the community board column by such multiplier value. An interface of the bonus game may be overlaid on an interface of the base game, where the base game may continue to be played by other players in the same game session that did not trigger the bonus game. As such, the bonus game interface may only be displayed to the players that contributed to filling the community board column that resulted in the play of the bonus game. This provides both an individualized and community experience, in that a bonus interface may only appear to the select few players that filled any given column of the community board. Once the bonus game ends, the players may be rejoined into the base game.

Additionally, landing certain symbols on the standard reel set may trigger play of a feature game. The feature game may include free spins and/or utilize hold & spin techniques as described herein. The feature game may include the standard reel set as part of the feature game. In some embodiments, the landing of a certain amount of special symbols will trigger the feature game. The special symbols that triggered the feature game may be held in place, and the other positions within the reels may spin so that new symbols may land. These new symbols may stack with the held special symbols to trigger wins in each free spin of the feature game, and/or may award additional free spins of the bonus game. Once the feature game concludes, the player may be apprised of the various winnings resulting from the feature game via a prize interface and be returned to the base game.

Each of the bonus game and the feature game may be accompanied by visual graphics and/or other audio and/or haptic sensations that may be presented when the player's wins from the bonus and/or feature game are tallied at the end of these games. These graphics, audio, and/or haptic sensations may celebrate the win and further drive engagement amongst groups of players and/or individual players.

The game may also include a boost feature where specialized boost symbols land on the standard reel set and boost certain other symbols on the standard reel set to a higher value and/or to a different type of symbol. For example, the boost symbol may upgrade (or boost) a first trigger symbol to a second different trigger symbol, where the second trigger symbol is the type of symbol that triggers populating a corresponding symbol into a column of the community board. These various trigger symbols may be embodied as cash-on-reel (COR) type symbols which may also include jackpot symbols, as described herein. The upgrading of the first trigger symbol to the second trigger symbol may be accompanied by certain visual graphics, audio, etc. to further drive excitement.

Additionally, an interface of the game may include communication features such as a chat interface where players can exchange messages with one another. The interface may also include other visual features such as displaying the profile picture and/or user name of players that had recent big wins, such as recent jackpot wins and/or other notable wins, and/or may include an option to invite other players into the game. All of these features increase excitement, engagement, and a sense of connectedness amongst players of the game.

Such community-based features as described herein represent a new gameplay dynamic not found in other electronic games. A technical problem exists in enabling gaming devices to improve social gaming amongst a group of players, with the capability to display one or more individualized award interfaces to a winning player or subset of winning players within the total group of players playing the game, while not showing the same one or more individualized award interfaces to any other players within the same game that did not win an award. In a conventional game with a community play feature, the game may stop playing while an award is being distributed to winners. The technical problems addressed herein include: (i) inability for known electronic games to provide dynamic community-based play; (ii) inability for known electronic games that include community play aspects to provide individualized playing experiences during community aspects of gameplay; and/or (iii) limited degrees of community play mechanics in known electronic games.

The resulting technical effect and/or technical benefits achieved herein include at least one of: (i) ability in electronic games to display a prize interface to a prize-winning player(s) while other (e.g., non-winning) players in the same playing session are still playing the base game and are not able to see the prize interface of the winning player(s); (ii) ability in electronic games to increase social engagement via social gameplay features utilizing a community board populated with game symbols contributed by communal players of the game; (iii) providing more degrees of variability and randomness in determining which features are provided in electronic games, without the need for additional computer resources such as computer processing and/or memory resources; and/or (iv) providing additional information and gameplay features to a user (e.g., player) of the electronic game within a limited amount of display space via an enhanced graphical user interface (GUI) of the game, including providing, via the GUI, additional information to the user during gameplay to apprise the user of the status of triggering a bonus game and/or a feature game and enhancement of prizes within the bonus game and/or the feature game.

The community board feature described herein may be configured as a “bolt on” feature that can be added to any variety of games using a standard reel set to add such social play aspects to the game.

More generally, electronic gaming devices can incorporate implementations described herein into various types of reel games or other games. These games can include a base mode (e.g., base game), a bonus mode (e.g., a bonus game), and/or feature mode (e.g., feature game or a free spin game).

A base mode, among other things, includes play that involves a sequence of reel spins, reel stops and win determinations of the stopped reels. That is, a single play of a reel game can constitute a single complete game or wager, e.g., a single spin of the reels or a series of spins and reel stops which culminate in a final aggregate outcome.

A bonus mode can, among other things, include play that involves a sequence of reel spins, reel stops and win determinations of the stopped reels once a certain bonus triggering event or sequence occurs in the base mode. For example, a bonus mode may include a multiplier wheel to be presented within the game interface that multiplies a win from the base mode by a certain multiple.

A feature mode can, among other things, add the possibility of winning alternative payouts potentially involving different target volatility criterion than the base game. A feature mode typically does not require an additional wager, but certain feature modes may require additional wagers. A feature mode may include a certain amount of free spins, where once the free spins are exhausted the feature mode ends and the player is returned to the base game. Additionally, during the feature game, spins that land certain combinations of symbols may trigger additional free spins to prolong the feature game.

An interface of the reel game may include a plurality of positions for one or more instances of symbols from a symbol set. Thus, the game interface may display a matrix of one or more symbol positions containing one or more symbol instances on a display of the electronic gaming device, and may include graphical elements such as highlighting or darkening to emphasize or de-emphasize one or more reels, symbol positions and/or symbol instances within the interface. The number of reels and dimensions thereof may depend at least on the type of display and the game implementation employed.

In some arrangements, the interface may include y reels with x symbol positions visible to the player. This display of y reels (also referred to as reel columns) with x symbol positions may be referred to as a reel set or a reel array. Of course, different reels can have different counts of symbol positions and, in turn, symbol instances possible.

For example, a reel set may display three symbol positions for a first reel, a second reel, a third reel, a fourth reel, and a fifth reel. Such a configuration can be described as a 3-3-3-3-3 configuration. For a typical game in base mode, a reel set may display a 3×5 configuration-five reels per reel set, with three symbol positions showing for each of the reels.

Other game array configurations are possible. For example, more generally, the interface may accommodate a reel array that spans m reels in a first dimension and spans n visible symbol positions in a second dimension orthogonal to the first dimension, where the value of m can be 4, 5, 6, 7, 8, or some other number of reels, and the value of n can be 2, 3, 4, 5, 6, or some other number of symbol positions.

Typically, the m reels are arranged horizontally from left-to-right, with the m reels spinning vertically and showing symbol positions of each of the visible portions of the respective reels. Alternatively, the m reels are arranged vertically in the reel window from top-to-bottom, with the m reels spinning horizontally and displaying symbol positions of each of the portions of the visible respective reels. Alternatively, other configurations may be configured.

For each of the reels, a reel strip may include z total positions along a one-dimensional strip of symbol positions, where z depends on implementation. For example, z may be 30, 70, 100, 140, or some other number of positions. Different sets of reels can be used for a base mode, bonus mode, feature mode, and/or other gaming mode. For example, for a feature mode, more valuable symbols, such as a wild symbol, can be added to the reels to trigger or enhance play of the feature mode. The value of z can be the same or different for different reels (thus, different reels can have different numbers of symbol positions).

In some implementations, the configuration of the symbol instances at the symbol positions of the reel strips for the reels of a reel game is fixed after the reel mode is initiated (e.g., boots), although limited reconfiguration operations may be permitted. In other implementations, the configuration of the symbol instances at the symbol positions of the reel strips for the reels of a reel game can change dynamically after the reel mode is initiated. The dynamic change could depend on bet amount or some other factor(s), for example.

The symbol set for the reels may comprise various types of symbols. For example, a symbol set may comprise a plurality of symbols, including a plurality of game symbols, a plurality of trigger symbols and a plurality of special symbols. The symbols can be static or animated. Depending on the application, the symbol set for the reels may comprise one or more special symbol types, at least one jackpot symbol type, a wild symbol type, a scatter symbol, and some number of picture symbol types, and some number of high/low symbol types.

The player initiates a spin for the base game (e.g., pushing a spin button, physical or digital). The spin uses the game/bet denomination, bet amount, and/or bet multiplier in effect (either default or selected by the player), assuming credits are sufficient in a credit meter. The credit meter decreases by the bet size.

In one example, for the spin of the reels in the base mode, a check may be made whether a feature mode is triggered. In particular, a random number may be generated (e.g., via an RNG call such as via RNG 212, described herein), and the random number is mapped to an outcome (e.g., that the feature mode is triggered, or that the feature mode is not triggered) using a lookup table. The lookup table that is used can depend on the bet amount. In this example, as the bet amount increases, the feature mode is more likely to be triggered, as reflected in weights for the possible outcomes in different lookup tables for different bet amounts. Alternatively, the feature mode can be triggered in some other way, e.g., by the occurrence of a game element, like the occurrence of a designated or predetermined symbol or set of symbols, or by the occurrence of a non-game occurrence. Similar techniques may be utilized in connection with the bonus mode.

As discussed, a feature mode may be awarded or triggered in an electronic gaming device. The feature mode may improve the technology of the electronic gaming device with the additional elements of chance, e.g., a Cash-on-Reel (COR) feature or symbol. The feature mode can utilize a different set of controls, different sets of reels, display screens, symbols, etc. than the base mode does in its normal operation. Alternatively, the feature mode can reuse or reconfigure at least some of the reels, display screens, symbols, etc. of a base reel game. The feature mode can be started in response to satisfaction of a trigger condition. For example, the feature mode can be initiated upon the occurrence of some defined combination of symbol instances, or a threshold count of certain symbol instances in one or more sets of reels. Alternatively, the feature mode can be triggered in some other way (e.g., randomly).

In one example, once a free games feature starts, the free games feature may continue without an input event. In other exemplary alternatives, one or more spins of the free games feature may be started or initiated in response to a user input event. The free games feature continues until all free games (spins) have been used. The number of free games depends on the count of instances of a scatter symbol that have landed to trigger the free games feature. The number of free games can be increased if the free games feature is “re-triggered” from within the free games feature. A scatter symbol may be a designated symbol that, once the threshold amount of scatter symbols land, trigger the feature game.

The outcome of the spin is then determined using all-ways evaluation, generally as described above for the base reel game. Alternatively, outcome evaluation can be performed using a different approach for a spin of the free games feature. In any case, after the outcome evaluation for a spin, any credits from winning combinations of symbol instances are shown in a win meter. The free games feature continues in a cycle of spin/stop/outcome evaluation until there are no more free games (spins). After the outcome evaluation for all spins of the free games feature, the total from the win meter is added to a credit meter and the free game feature reverts to the base or other game mode.

In some implementations, if at least a threshold count (e.g., six or more) of instances of a scatter symbol may land in any position, a feature game feature may be triggered. In a feature game mode, a transition to the feature games feature occurs, and the feature game runs according to its designated routine as described herein.

In some embodiments, if at least a threshold count (e.g., a full column) of instances of another type of symbol land, a bonus game may be triggered. The bonus game may be a spin of a wheel that multiplies an amount won via the symbols that landed in the reel set of the base game just prior to the triggering of the bonus game, such that the result of the bonus game modifies the amount won. The bonus game may have a shorter duration than the feature game. In some embodiments, the playing of the bonus game may be a “one-and-done” scenario where, in the example above, the result of playing the bonus game is only one spin of the wheel, as opposed to the feature game where additional free spins may be awarded to prolong the feature game duration.

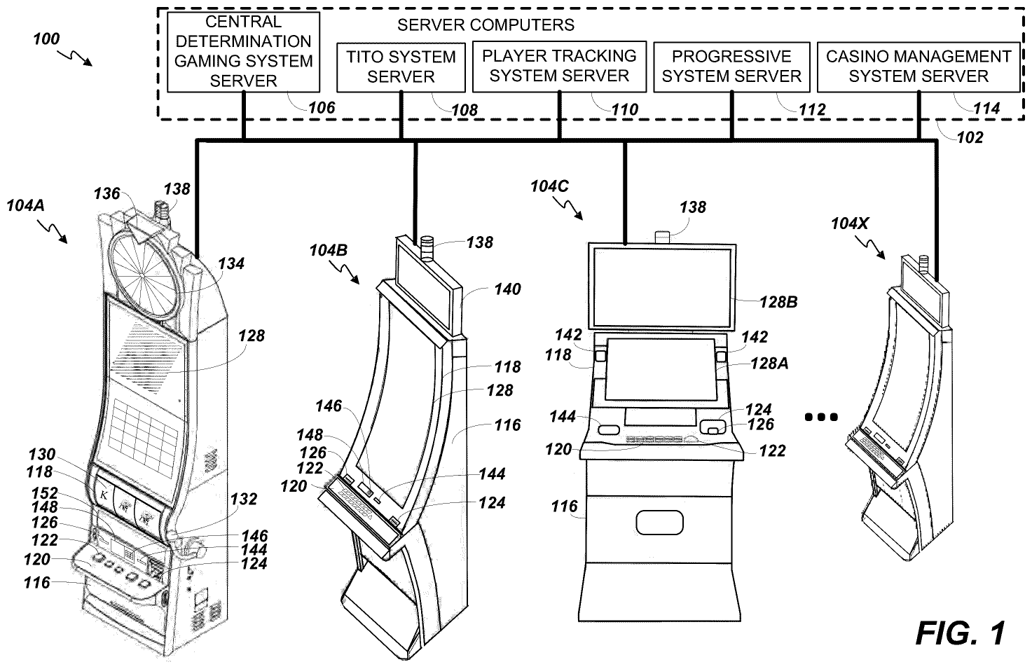

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 including a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.01, $0.02, $0.05, or $0.10), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate gameplay.

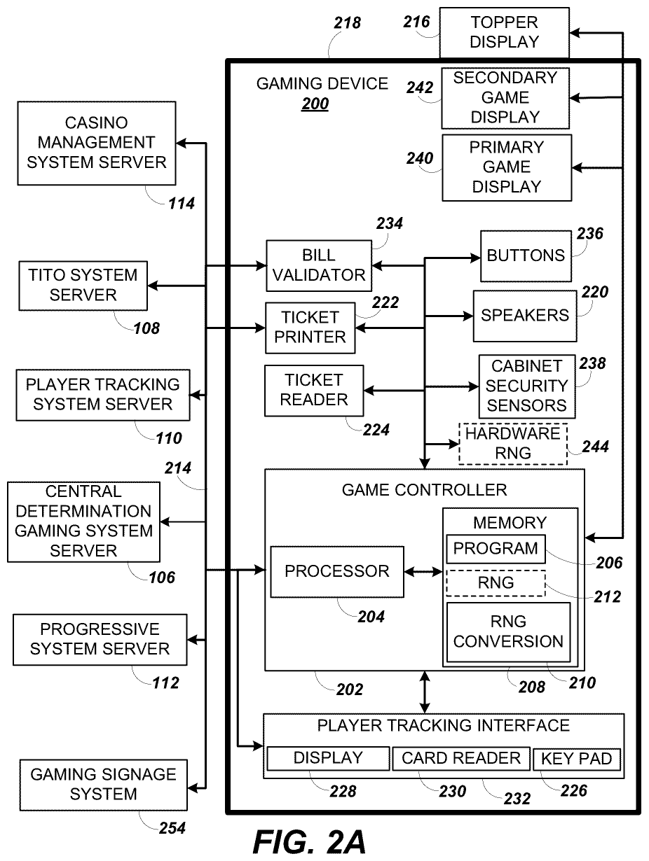

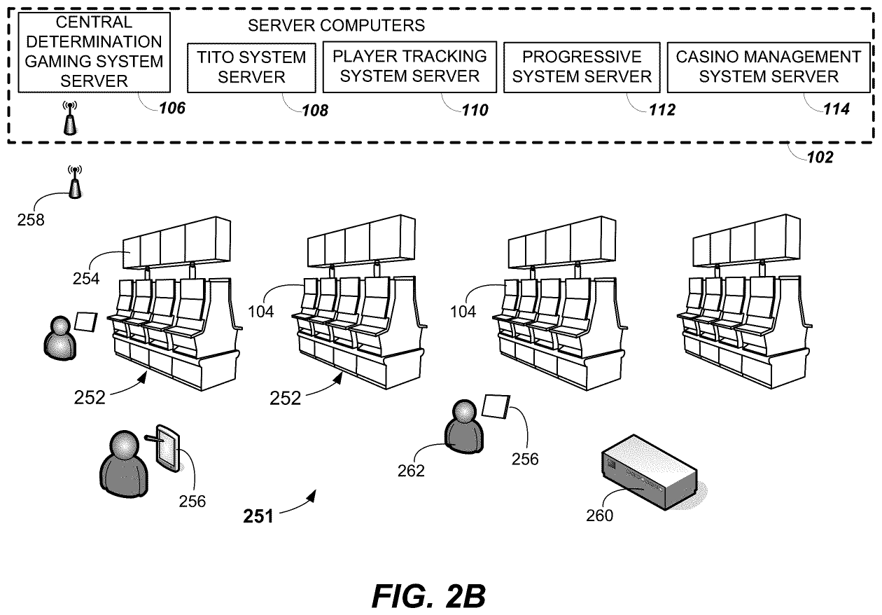

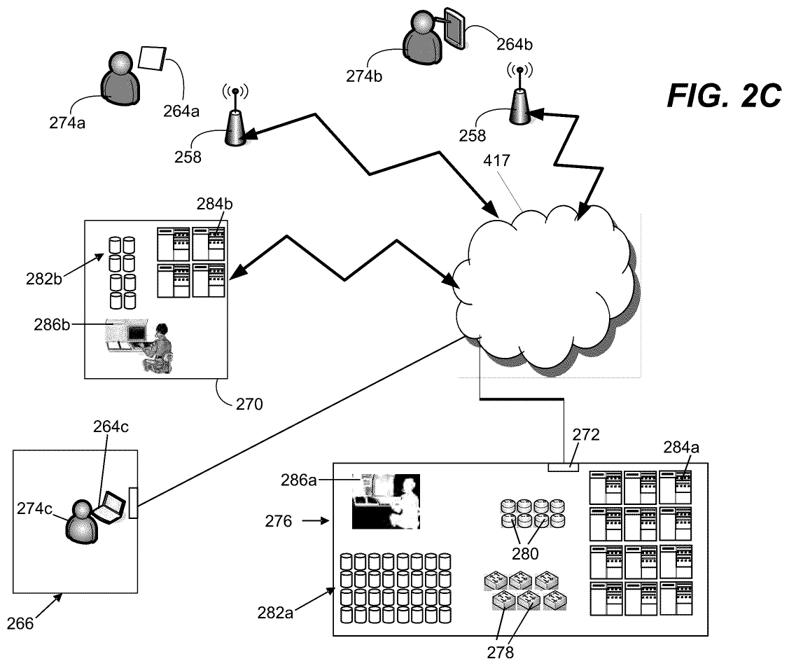

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows gameplay functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary gameplay while secondary display 128B is typically used for bonus gameplay, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of gameplays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more user interfaces (UIs), the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of gameplay (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104A-104X. In this example, each bank 252 of EGMs 104A-104X includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104A-104X, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real (e.g., physical) button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron.

Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online gameplay. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online gameplay, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

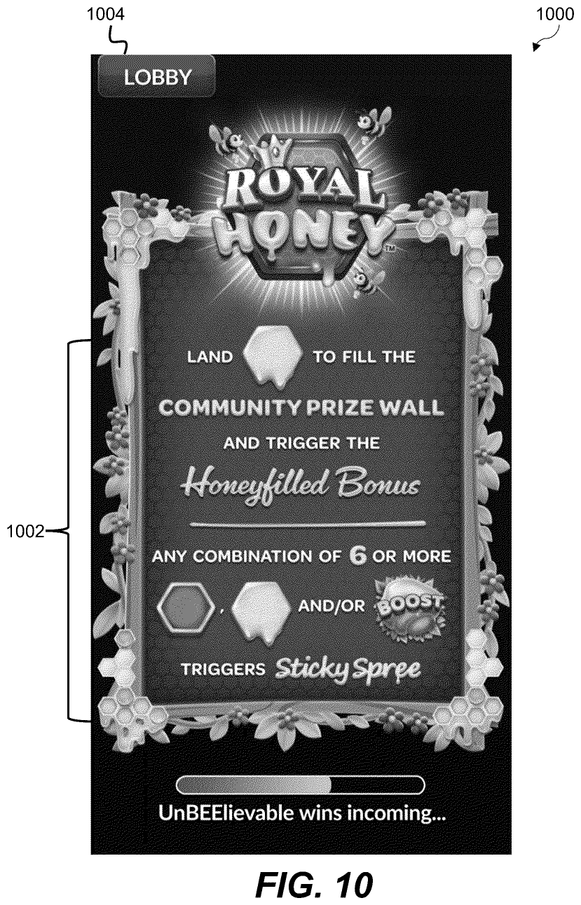

A brief description of electronic gaming via EUDs 264a, 264b, and 264c follows. Implementations described herein may be implemented in a gaming server 102 and/or EUDs 264a, 264b, and 264c as described with reference to FIGS. 1 and 2A-2C. Thus, a gaming server 102 and/or EUDs 264a, 264b, and 264c is/are an example of an electronic gaming device as described herein. The game processing backend system and graphical user interface system can be implemented using memory and one or more processors that are part of the electronic gaming device and/or part of a gaming system located remotely from the electronic gaming device. Depending on implementation, the backend system and graphical user interface system can be implemented by software executable on a CPU, by software controlling special-purpose hardware (e.g., a GPU or other graphics hardware for video acceleration), and/or by special-purpose hardware (e.g., in an ASIC), to process game play instructions in accordance with game play rules, determine outcomes in accordance with game play rules, and/or generate outputs (e.g., to one or more display screens and/or speakers). A display screen of the electronic gaming device may display one or more interfaces of the game, such as the interfaces shown in FIGS. 10A-16E.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

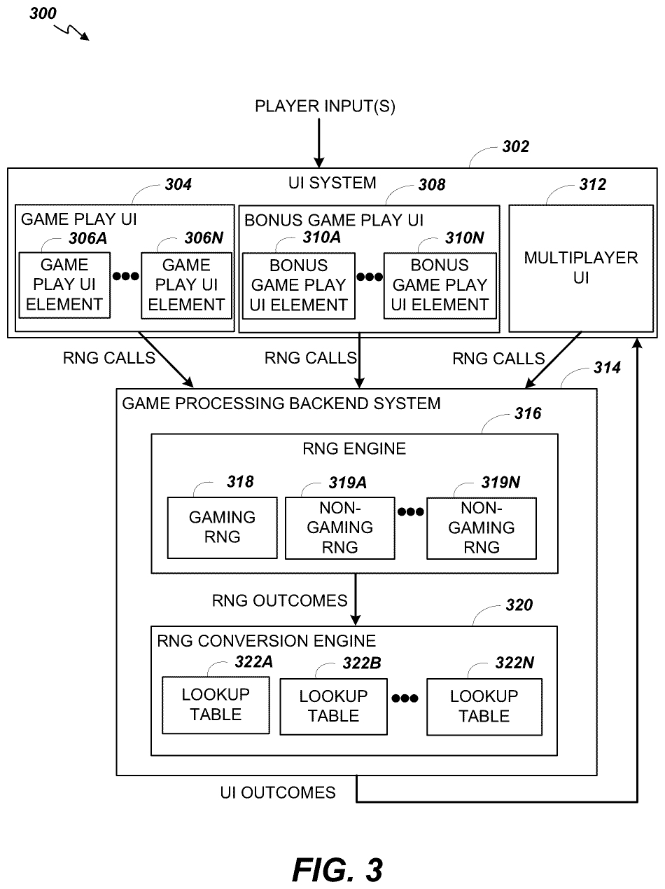

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more gameplay UIs 304, one or more bonus gameplay UIs 308, and one or more multiplayer UIs 312, where each UI type includes one or more mechanical UIs and/or graphical UIs (GUIs). In other words, gameplay UI 304, bonus gameplay UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present gameplay to a player. Using FIG. 3 as an example, the different UI elements are shown as gameplay UI elements 306A-306N and bonus gameplay UI elements 310A-310N.

The gameplay UI 304 represents a UI that a player typically interfaces with for a base game. During a game instance of a base game, the gameplay UI elements 306A-306N (e.g., GUI elements depicting one or more virtual reels) are shown and/or made available to a user. In a subsequent game instance, the UI system 302 could transition out of the base game to one or more bonus games. The bonus gameplay UI 308 represents a UI that utilizes bonus gameplay UI elements 310A-310N for a player to interact with and/or view during a bonus game. In one or more implementations, at least some of the gameplay UI element 306A-306N are similar to the bonus gameplay UI elements 310A-310N. In other implementations, the gameplay UI element 306A-306N can differ from the bonus gameplay UI elements 310A-310N.

FIG. 3 also illustrates that UI system 302 could include a multiplayer UI 312 purposed for gameplay that differs or is separate from the typical base game. For example, multiplayer UI 312 could be set up to receive player inputs and/or presents gameplay information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament gameplay. After tournament gameplay ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for gameplay. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more gameplay UI elements 306A-306N, such as symbols, for the gameplay UI 304. In another example, if the UI outcome is for a bonus game, the UI system could update one or more bonus gameplay UI elements 310A-310N (e.g., symbols) for the bonus gameplay UI 308. In response to updating the appropriate UI, the player may subsequently provide additional player inputs to initiate a subsequent game instance that progresses through the game processing pipeline.

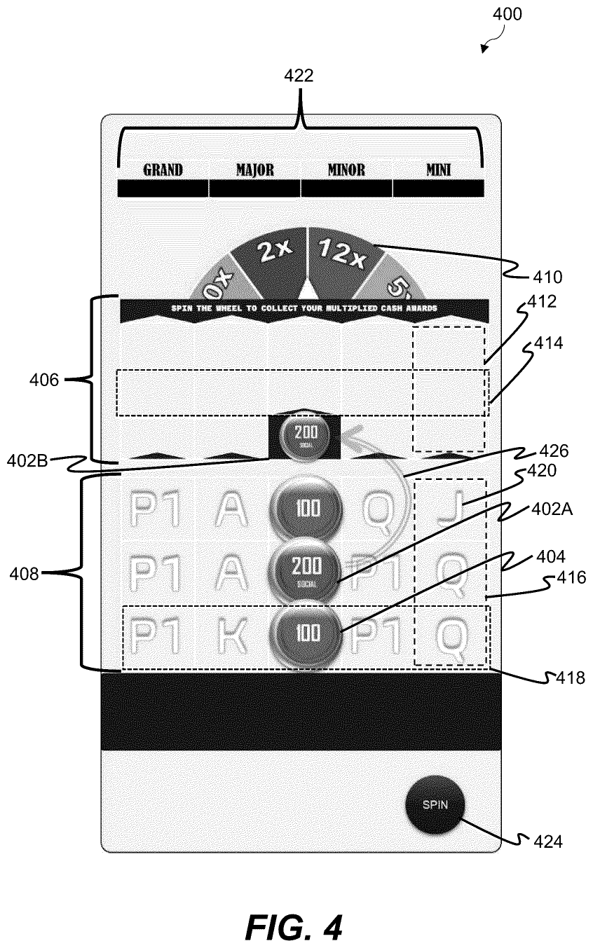

FIG. 4 illustrates an example embodiment of gameplay mechanics of a base game, including an interface 400 of the base game according to one embodiment of the present disclosure. As shown, interface 400 includes a plurality of features including a reel set, a community matrix adjacent the reel set, a multiplier wheel adjacent the community matrix, and a plurality of symbols that may appear on either or both of the reel set and the community matrix. More specifically, a trigger symbol 402A, also referred to as a social trigger symbol 402A, may be embodied as a social cash-on-reel (COR) symbol. Social trigger symbol 402A may be configured to land on the reel set and trigger a corresponding community social trigger symbol 402B to be deposited within a corresponding column of a community matrix 406 (which may also be referred to herein as a community board). Additionally, normal trigger symbols 404 may land on the reel set. A normal trigger symbol 404 may be embodied as a normal COR symbol. Normal trigger symbols 404 may also be an embodiment of a scatter symbol, where if a certain amount of normal trigger symbols 404 land, a feature game may be triggered as described herein. However, normal trigger symbols 404 may be configured to not trigger a corresponding community social trigger symbol to land in a corresponding column of community matrix 406 (unless a given normal trigger symbol 404 is upgraded to a social trigger symbol 402A, as described herein).

A reel set 408 is the primary (or “standard”) reel set of the base game where symbols such as social trigger symbols 402A and normal trigger symbols 404 may land during play of the base game depending on the rules of the base game and the RNG calls from an RNG such as RNG 212 that generate the symbols. Social trigger symbols 402A have their own associated value and may function to trigger the population of community matrix 406 with corresponding community social trigger symbols 402B. Interface 400 may include a multiplier wheel 410 that includes a plurality of multipliers that may function to multiply an amount won (e.g., during a spin of the base game) when a wheel spin of multiplier wheel 410 is triggered, depending on which multiplier lands after the spinning of multiplier wheel 410. Spinning of wheel 410 may be reserved for a bonus game. Community matrix 406 may include one or more columns 412 and one or more rows 414. Reel set 408 may include one or more columns 416 and one or more rows 418. In some embodiments, community matrix 406 may include a same amount of columns 412 and rows 414 as the amount of columns 416 and rows 418 of reel set 408. For example, each of community matrix 406 and reel set 408 may be a 3×5 configuration including three rows and five columns. This is but one potential configuration and other configurations (e.g., 4×5, 5×5, etc.) may be configured.

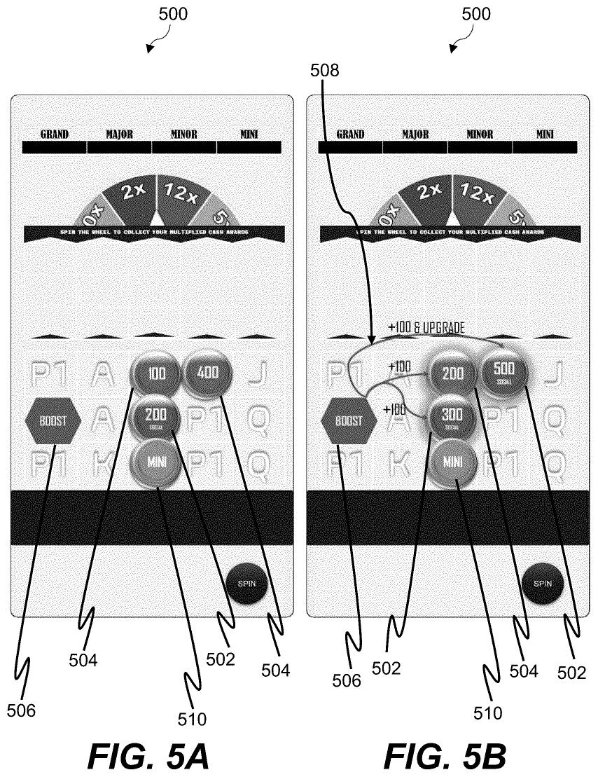

With reference to FIG. 4, the base game may include, without limitation: (1) a lines game played on reel set 408; (2) symbols 420 that land on reel set 408, where symbols 420 may include (i) wild symbols, (ii) standard high and low symbols, (iii) social trigger symbols 402A, (iv) normal trigger symbols 404, which may also function as scatter symbols, (v) boost symbols (shown in and described in connection with FIGS. 5A and 5B); and (vi) other feature symbols, including a boosted normal trigger symbol that has been boosted to a social trigger symbol; (3) community matrix 406, and multiplier wheel 410 which may include a variety of multiples that may multiply an amount resulting from a certain combination of symbols 420 that land on reel set 408; and (4) a feature game (e.g., which may be named “Sticky Spree”) accessible based on landing certain symbols 420 within the base game. A jackpot indicator 422 may be present within interface 400 to indicate which of a plurality of jackpots (e.g., Grand, Major, Minor, Mini) may be active and/or winnable during gameplay, along with the amount (not shown) corresponding to each jackpot. A spin button 424 may be present within interface 400 to permit a player to activate spin button 424 to spin reels of reel set 408. As shown by arrow 426 in FIG. 4 and as described in more detail herein, when a social trigger symbol 402A lands within a column 416 of the base game, a corresponding community social trigger symbol 402B may be deposited on a matching column of community matrix 406. For example, as shown in FIG. 4, the landing of social trigger symbol 402A in the middle column of reel set 408 triggers a corresponding community social trigger symbol 402B to be deposited in the middle column of community matrix 406. Additional aspects of the manner in which community social trigger symbols 402B populate community matrix 406 are described herein.

FIGS. 5A and 5B illustrate an example embodiment of a gameplay interface 500 of the base game including boost functionality, where interface 500 may be the same as or similar to interface 400 shown in and described in connection with FIG. 4. FIGS. 5A and 5B illustrate a boost feature of the base game, and show how social trigger symbols 502 that land on the base game reel set, as well as normal trigger symbols 504 that may land on the base game reel set, may be boosted to a higher value COR symbol and/or boosted to a different type of symbol upon a boost symbol 506 landing and triggering a boost feature indicated by arrows 508 within the base game. Boost symbol 506 may land on the reel set during play of the base game and is configured to boost the value of certain other symbols that may be present on the reel set. For example, when boost symbol 506 lands on the reel set it may boost the value (or type) of any symbols 502 and/or 504 (e.g., COR symbols) that may be present on the reel set (although boost symbol 506 may be configured to not boost a value of any jackpot symbol that may land on any given spin). Boost symbol 506 may be limited in that only one boost symbol 506 can land on any given spin. All symbols 502 and 504 (e.g., COR symbols) present on the reel set may be boosted by a random value provided by boost symbol 506, such as being boosted between 0.5 times bet to 5 times (e.g., ×5) bet. The boost value of boost symbol 506 may be determined by an RNG call such as by RNG 212. FIGS. 5A and 5B also show a jackpot symbol 510 that may land and correspond to a particular jackpot (e.g., Grand, Major, Minor, Mini, where jackpot symbol 510 shown in FIGS. 5A and 5B corresponds to a “MINI” jackpot). However, jackpot symbol 510 may not be boosted to a higher level jackpot by virtue of any boost symbol 506 that lands. That is, a boost symbol 506 would not boost the “MINI” jackpot associated with jackpot symbol 510 to a “MINOR” or higher level jackpot (and likewise for other jackpots that may be associated with jackpot symbol 510).

Arrows 508 show examples of the various value boosts that boost symbol 506 may provide to COR symbols 502 and 504 present on the reel set. For example, the 200 value social trigger symbol 502 shown in FIG. 5A may be boosted by +100 to a 300 value social trigger symbol 502 shown in FIG. 5B. The 100 value normal trigger symbol 504 shown in the middle column of the reel set of FIG. 5A may be boosted by +100 to a 200 value normal trigger symbol 504 shown in FIG. 5B. The 400 value normal trigger symbol 504 shown in the column to the immediate right of the middle column of the reel set of FIG. 5A may be boosted by +100 and upgraded to a 500 value social trigger symbol 502 as shown in FIG. 5B. However, as described above, jackpot symbol 510 stays at the same level, as shown by a comparison of FIG. 5A with FIG. 5B. As shown in FIGS. 5A and 5B, boost symbol 506 not only boosts the values of symbols 502 and 504 (e.g., COR symbols) but may also turn any number of normal trigger symbols 504 (e.g., at least one normal trigger symbol 504) to social trigger symbols 502.

Some embodiments may include a hold & spin feature (e.g., where a certain combination of symbols that land cause certain reels or certain positions within the reels of the reel set to hold while other reels/positions within reels continue to spin and land additional symbols in the successive spins). If a hold & spin feature is triggered via boost symbol 506, the boost symbol 506 may be replaced with a blank symbol on entering the hold & spin feature. The hold & spin feature may occur on the reel set of the base game during play of the base game, and/or on the reel set of a play of a feature game, as described herein.

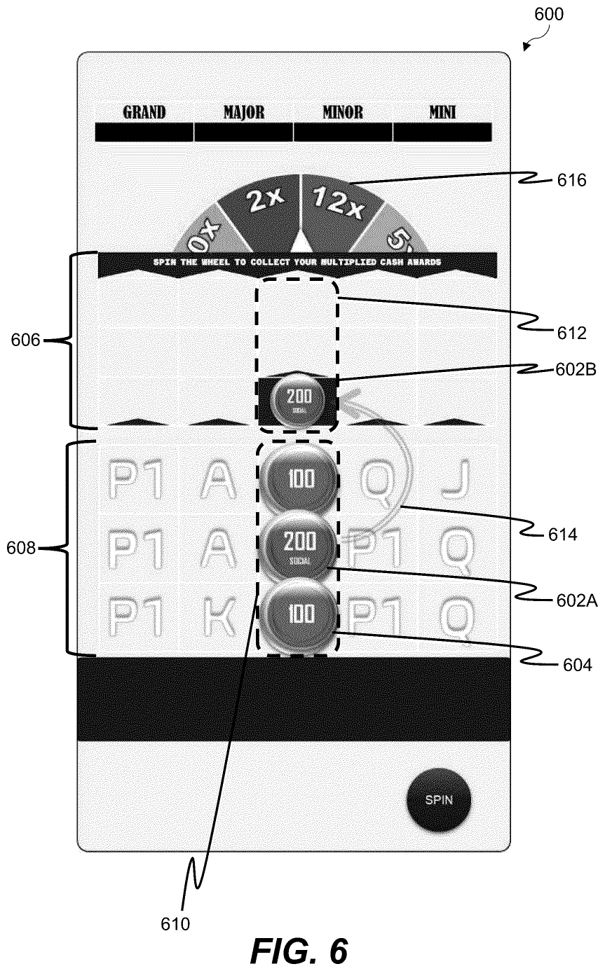

FIG. 6 illustrates an example embodiment of a gameplay interface 600 of the base game, where interface 600 is the same as or similar to interfaces 400 and 500 shown in and described in connection with FIGS. 4 and 5A/5B, respectively. FIG. 6 illustrates social trigger symbol 602A, community social trigger symbols 602B, and normal trigger symbols 604, and the functionality of how community social trigger symbols 602B collect in columns of community matrix 606 that match columns in which social trigger symbols 602A land in reel set 608. More specifically, when a social trigger symbol 602A lands in a column such as column 610 of reel set 608, a corresponding community social trigger symbol 602B is populated in a matching column 612 of community matrix 606, as indicated by arrow 614. Each column of community matrix 606 such as column 612, when filled (e.g., three community social trigger symbols 602B populate the given column) awards a prize such as a wheel spin of multiplier wheel 616 to the players that contributed to filling the column by landing one or more social trigger symbols 602A in reel set 608, which may take place as part of a bonus game.

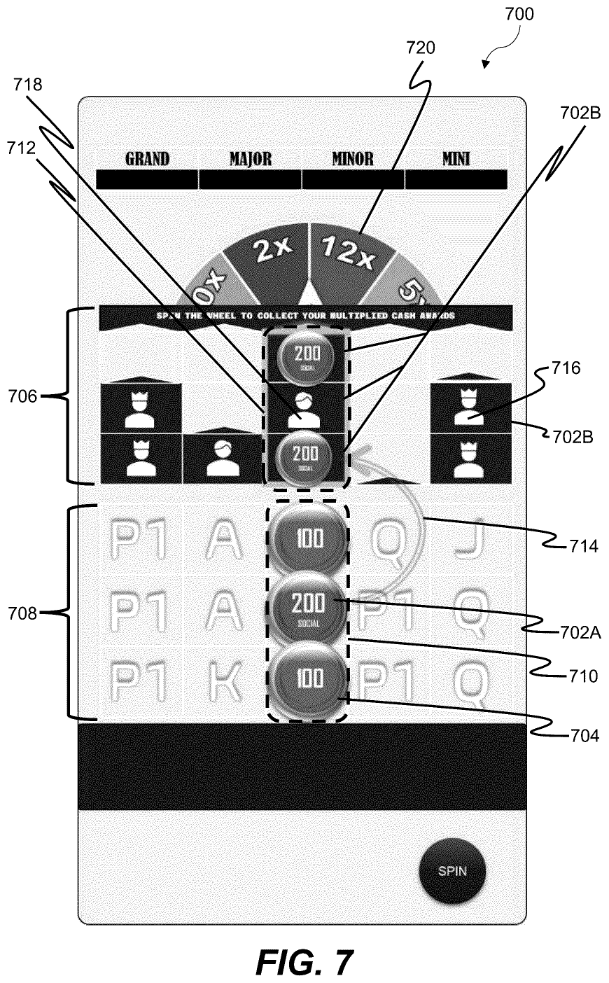

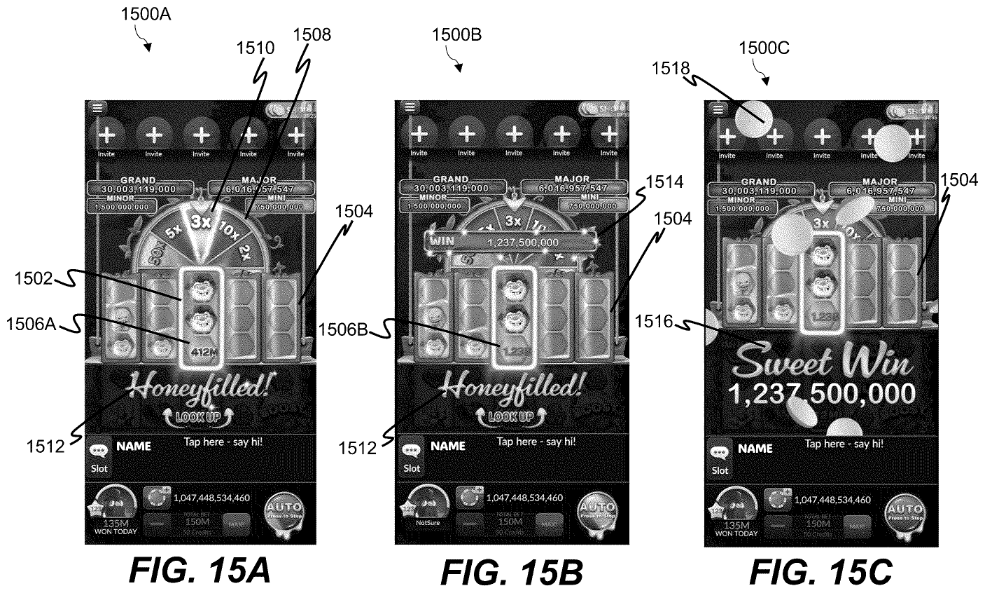

FIG. 7 illustrates an example embodiment of a gameplay interface 700 of the base game, where interface 700 is the same as or similar to interfaces 400/500/600 shown in and described in connection with FIGS. 4/5A and 5B/6, respectively. FIG. 7 illustrates social trigger symbol 702A, community social trigger symbols 702B, and normal trigger symbols 704, and the functionality of how community social trigger symbols 702B collect in columns of community matrix 706 that match columns in which social trigger symbols 702A land in reel set 708. More specifically, when a social trigger symbol 702A lands in a column such as column 710 of reel set 708, a corresponding community social trigger symbol 702B is populated in a matching column 712 of community matrix 706, as indicated by arrow 714. Players in the current game session may contribute community social trigger symbols 702B to community matrix 706 when a result of their spin lands a social trigger symbol 702A in their individual reel set 708 or a normal trigger symbol 704 is boosted, such that community matrix 706 is populated with community social trigger symbols 702B from one or more players playing the same base game session. In a 3×5 row/column embodiment, community matrix 706 may include 15 spots to be filled, and may show spots filled by the contributing players via avatars such as avatars 716 and 718 that may match avatars as set by the players. Avatars such as avatars 716 and 718 may be profile pictures set by the players. In FIG. 7, each spot of community matrix 706 that is filled indicates a spot that has received a corresponding community social trigger symbol 702B contributed either by the current player and/or other players playing within the same base game session as the current player. The fact that some spots are filled with a representation (e.g., “200”) of a community social trigger symbol 702B while other spots are filled with an avatar such as 716 and/or 718 merely reflects the underlying mechanics of the population of community matrix 706 being populated. For example, the “200” values shown in FIG. 7 would not be shown in the actual game interface and would instead be a graphical symbol such as an avatar or other profile picture of the current player, and more specifically an avatar the same as or similar to avatars 716, 718. An exemplary depiction of the filling of the spots of the community matrix in an example actual game interface is shown in more detail in FIGS. 15A to 15C.

When each column such as column 712 of community matrix 706 is filled (e.g., column 712 is filled with three community social trigger symbols 702B), an award such as a play of a bonus game which may include a wheel spin via multiplier wheel 720 may be granted to one or more of the players that contributed to filling column 712 by their landing of a social trigger symbol 702A in reel set 708. As shown in FIG. 7, column 712 has been filled by the current player playing the game, who may have contributed two 200 community social trigger symbols 702B, as well as another different player represented by avatar 718. More specifically, the current player may have contributed the first (or bottom) community social trigger symbol 702B in column 712, the other player represented by avatar 718 contributed the second (or middle) social trigger symbol (not shown) in column 712, and the current player contributed the third (e.g., top, or final) community social trigger symbol 702B in column 712. Avatars 716 and 718 are merely examples, and there may be any number of avatars representing the amount of players playing the base game and contributing to the community matrix.

In some embodiments, the filling of a column such as column 712 with the necessary amount (e.g., three) community social trigger symbols 702B by one or more players in the game session awards access to a bonus game of the base game that may include one or more spins of multiplier wheel 720 to players that contributed to the filling of column 712 by virtue of landing social trigger symbols 702A in a corresponding column (e.g., column 710) in reel set 708 of the base game. Wheel 720 spins to determine the multiplier award (e.g., 10×, 2×, 12×, 5×, etc.), and the players that contributed to filling column 712 may be awarded the same wheel outcome. In other embodiments, the player that triggers the filling of a column such as column 712 via contribution of the third (e.g., final) community social trigger symbol 702B in column 712 may be awarded a higher level prize or an additional prize than the other players that contributed to the filling of column 712 via the prior two community social trigger symbols 702B (but that did not contribute the final community social trigger symbol 702B that filled the column (e.g., column 712)). Avatars 716, 718, etc. may also appear on a top portion of interface 700 to display the bonus game hit for all players triggering a spin of wheel 720 (as shown in and described in connection with FIGS. 15A to 15C).

FIG. 8 illustrates an example embodiment of an interface element that is a multiplier wheel 800 of the base game, and may be the same as or similar to multiplier wheel 410 shown in FIG. 4, multiplier wheel 616 shown in FIG. 6, and multiplier wheel 720 shown in FIG. 7. Wheel 800 may be divided into a plurality of sections (e.g., 10 sections), with each section including a certain multiplier. The multipliers may include various multiplier levels such as a 2× multiplier 802, a 4× multiplier 804, a 5× multiplier 806, an 8× multiplier 808, a 10× multiplier 810, a 12× multiplier 812, and a 15× multiplier 814, some of which may occur more than once on wheel 800. These multipliers are merely examples and other multiples (e.g., 3×, 6×, etc.) may be used. Wheel 800 may be implemented as part of a bonus game within the base game, as shown in and described in connection with FIGS. 15A to 15C.

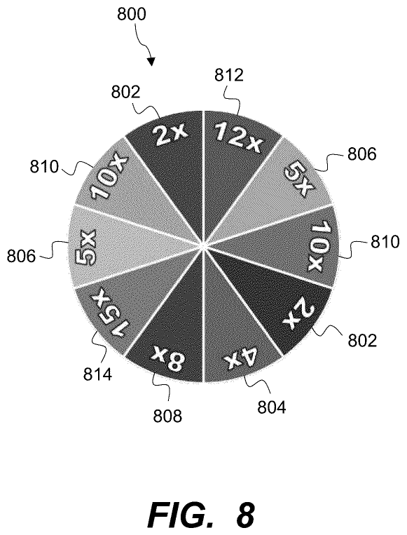

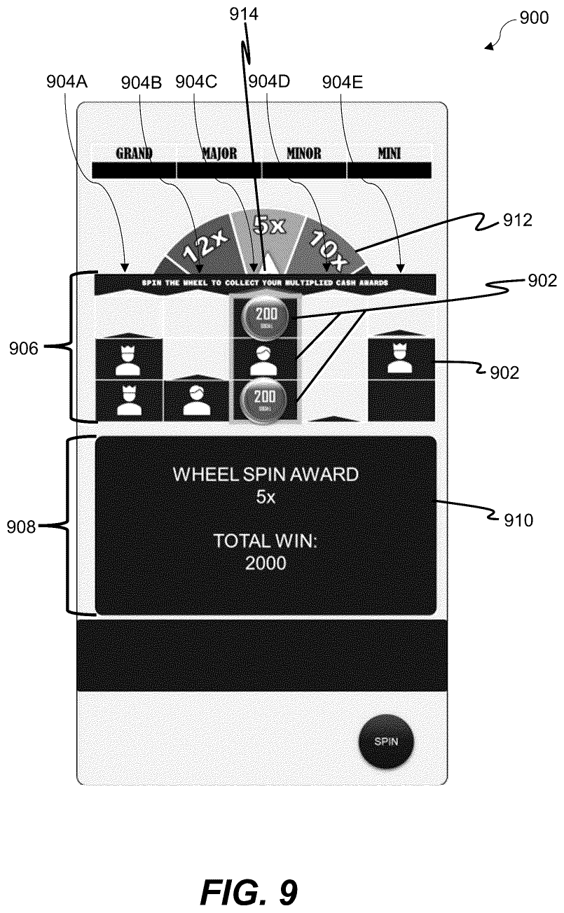

FIG. 9 illustrates an example embodiment of a gameplay interface 900 of the base game, where interface 900 is similar to interfaces 400/500/600/700 shown in and described in connection with FIGS. 4/5A and 5B/6/7, respectively, but where the reel set is overlaid with a graphic indicating a result of a bonus game play where a wheel was spun. FIG. 9 illustrates a plurality of community social trigger symbols 902 populating columns such as columns 904A, 904B, 904C, 904D, and 904E of community matrix 906, each community social trigger symbol 902 representing a social trigger symbol that landed in a corresponding column of reel set 908. However, in FIG. 9, reel set 908 is overlaid with a bonus game graphic 910 to display to the player a result of a wheel spin of a multiplier wheel 912 such as from a play of a bonus game in which wheel 912 was triggered. Graphic 910 may display a wheel outcome showing the multiplier that arrow 914 of wheel 912 landed on as well as a total win resulting from the value of the CORs multiplied by the wheel multiplier. In the example shown in FIG. 9, a 5× multiplier lands as indicated by arrow 914 of wheel 912, and given that there are two social trigger symbols each having a value of 200, the total win may be 2,000 (e.g., ((200+200)×5)=2,000), as shown in graphic 910. This is just an example calculation and is not limiting. The multiplier on which wheel 912 lands may be from an RNG call such as from RNG 212. FIGS. 4, 5A, 5B, and 6-9 represent backend interface and gameplay mechanics that control how the game functions and that may not be visible to players in embodiments of actual games (e.g., such as shown in FIGS. 10-13, 14A-14C, 15A-15C, and 16A-16E) that utilize the backend interface and gameplay mechanics shown in and described in connection with FIGS. 4, 5A, 5B, and 6-9.

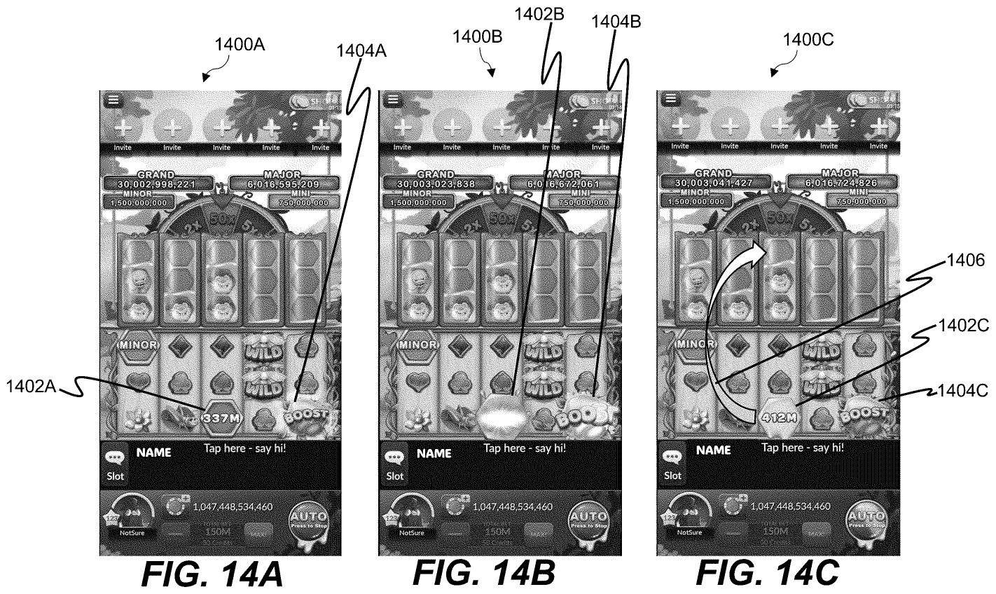

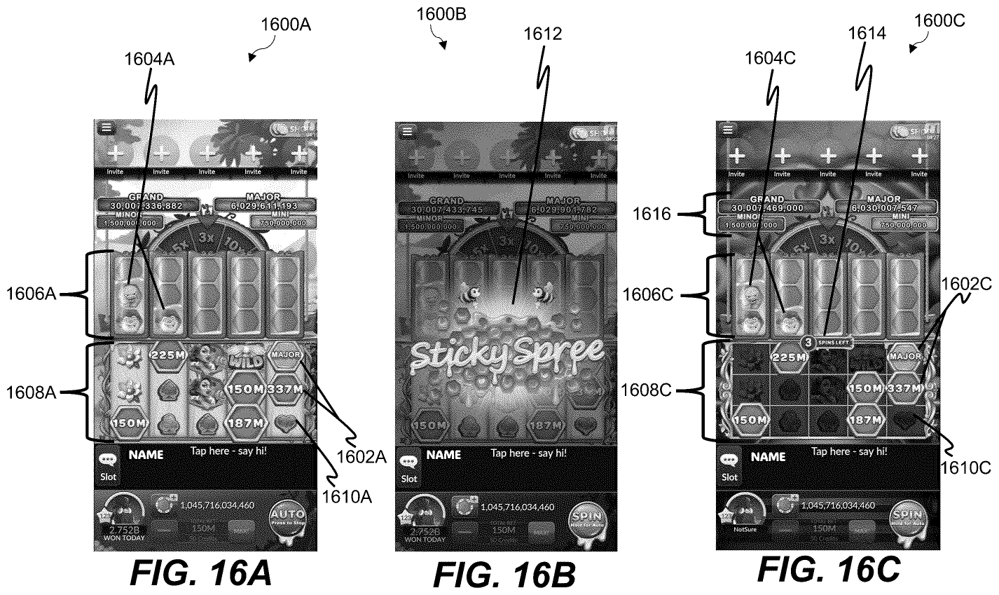

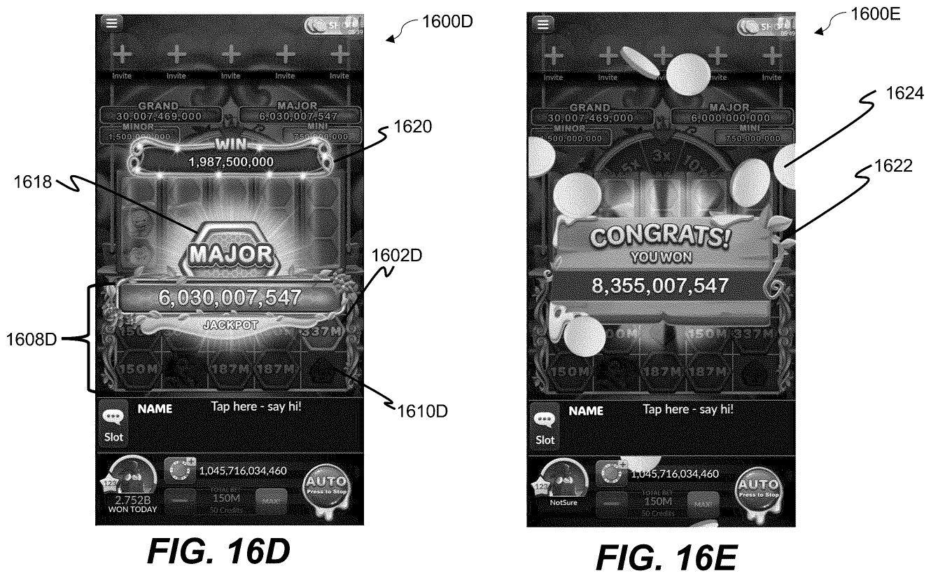

FIGS. 10-16E illustrate an example electronic (e.g., mobile) game embodiment that embodies the interface and gameplay mechanics shown in and described in connection with FIGS. 1, 2A-2C, 3, 4, 5A, 5B, and 6-9. Certain of these figures may be viewed as being in sequence, e.g., a playing sequence of a game session, and/or individually. More specifically, FIGS. 14A-14C may be viewed as illustrating a sequence of the boost function according to one embodiment, FIGS. 15A-15C may be viewed as illustrating a sequence of a bonus game according to one embodiment, and FIGS. 16A-16E may be viewed as illustrating a feature game according to one embodiment. While FIGS. 10-16E describe a mobile game embodiment, the interface and gameplay mechanics shown in and described in connection with FIGS. 4, 5A, 5B, and 6-9 may be embodied via a game played via an EGM and/or other game types as described herein.

FIG. 10 illustrates an example introduction/loading interface 1000 for entry into an electronic (e.g., mobile) game embodying aspects of the interfaces, gameplay mechanics, and/or other systems and methods which is/are shown in and described in connection with FIGS. 1, 2A-2C, 3, 4, 5A, 5B, and 6-9, where interface 1000 may present therein a graphical explanation 1002 of rules of the game and have one or more user interface buttons 1004 which may be configured to provide various functions such as to return to a lobby of the game. The mobile game may have a name corresponding to a certain theme present in the game, such as “Royal Honey.” The mobile game may be presented and/or played on devices such as EUDs 264a, 264b and 264c shown in FIG. 2C.

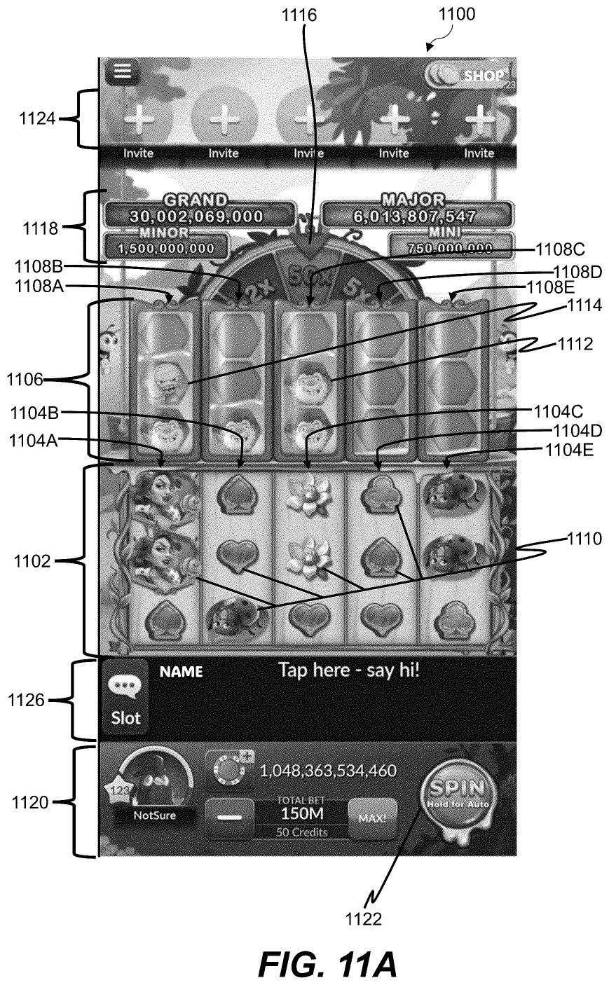

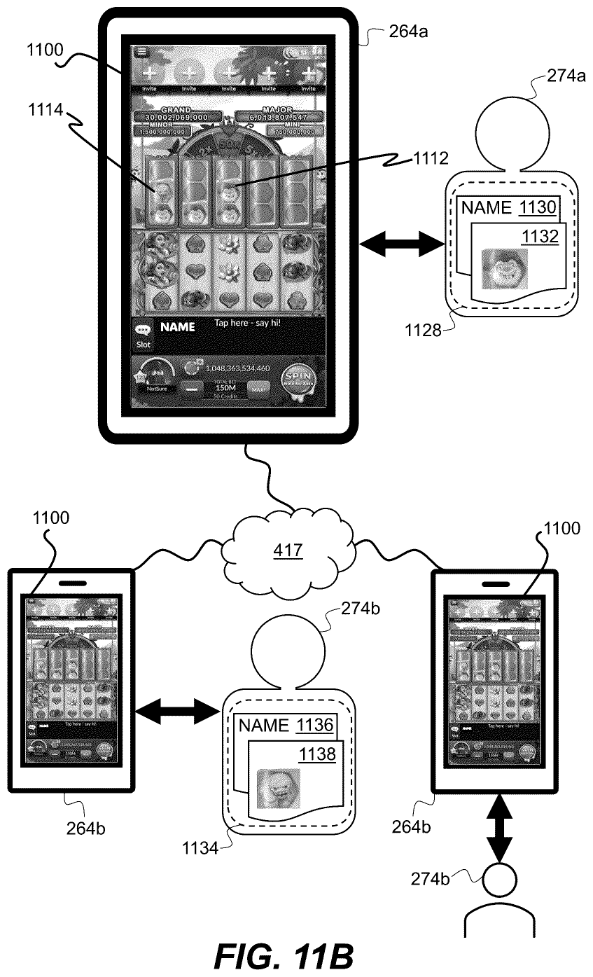

FIG. 11A illustrates an example interface 1100 of a base game of the mobile game, including a reel set 1102 (e.g., representing an implementation of the reel sets shown in FIGS. 4, 6, 7) including a plurality of reel columns 1104A, 1104B, 1104C, 1104D, and 1104E and a community board 1106 (e.g., representing an implementation of the community matrix shown in each of FIGS. 4, 6, 7) including a plurality of community board columns 1108A, 1108B, 1108C, 1108D, 1108E. Reels 1104A to 1104E may initially include various standard symbols 1110, and community board 1106 may be populated with community social trigger symbols 1112 and 1114 of players whose spins in the base game have triggered contributions of such corresponding symbols to community board 1106 as described herein. For example, community social trigger symbols 1112 and 1114 may be implemented as an avatar of the player whose play in the base game contributed the social trigger symbols to community board 1106.

Interface 1100 also includes a multiplier wheel 1116 and a jackpot indicator section 1118 indicating various jackpot types and their values (e.g., Grand, Major, Minor, Mini) at a portion such as a top portion of interface 1100 near wheel 1116 (e.g., representing an implementation of wheel 410 shown in FIG. 4). Multiplier wheel 1116 may appear in a de-activated (e.g., darkened) state when inactive, such as when the base game is being played and no bonus game featuring wheel 1116 has been activated. If wheel 1116 is active, it may be displayed within interface 1100 in full color (e.g., not darkened) including any associated animations, sounds, etc. Wheel 1116 may also be located visually within interface 1100 as being behind and/or partially obstructed by community board 1106 and/or jackpot graphics within jackpot section 1118. Another portion such as a lower portion of interface 1100 may include user interface elements 1120 such as a spin button 1122, as well as player profile information (e.g., profile picture, (e.g., total) amount won), a bet amount (with options to increase or decrease), a chat feature, etc. Spin button 1122 may include a “Hold for Auto” function where if spin button 1122 is held (e.g., pressed) for a certain amount of time by a player, spin button 1122 will convert to an auto-spin button instead of a single spin button (wherein a player may revert to the single spin button by holding spin button 1122 again for the necessary duration of time). Interface 1100 may also include indicator portion 1124 that may be populated with profile pictures and/or user names of recent winners of a jackpot (e.g., the circled+sign interface elements at top) or profile pictures and/or user names of other players invited to play by players currently playing the game. A chat feature 1126 may be utilized in a portion such as a lower portion of interface 1100 that may enable players to chat with one another. Each of reel set 1102 and community board 1106 may be configured with a certain amount of rows and columns, for example in a 3×5 configuration with three rows and five columns, with the columns aligned as shown by columns 1104A-1104E and columns 1108A-1108E in FIG. 11. This is non-limiting and other configurations (e.g., 4×5, etc.) may be used). When viewed in sequence, interface 1100 may be an interface that appears subsequent to interface 1000 shown in FIG. 10 during gameplay.

FIG. 11B illustrates an example of community-based gameplay of the mobile game. With reference to FIG. 2C, FIG. 11B illustrates a plurality of users such as user 274a and a plurality of users 274b, where users 274a, 274b are players of the mobile game. Each player has a respective EUD such as EUD 264a (e.g., a tablet) for user 274a, and EUDs 264b (e.g., smartphones) for users 274b, where EUDs 264a and 264b are connected to the mobile game via network 417. The game may require players to create a player profile, which may include a user name and/or other user aspects such as a profile picture, linked payment accounts, loyalty accounts, and/or other user data such as an email address, real name, address, etc. For example, user 274a may have a player profile 1128 that stores therein a user name 1130 and a profile picture 1132. Similarly, one of users 274b may have a player profile 1134 that stores therein a user name 1136 and a profile picture 1138, and so on and so forth for the other plurality of users such as additional users 274b. With reference to interface 1100, user 274a may have landed a social trigger symbol in the reel set of the base game so as to contribute community social trigger symbol 1112, such that profile picture 1132 of user 274a may be shown as part of the symbol for the contributed community social trigger symbol 1112. Similarly, a user 274b may have landed a social trigger symbol in the reel set of the base game so as to contribute community social trigger symbol 1114, such that profile picture 1138 of user 274b may be shown as part of the symbol for the contributed community social trigger symbol 1114. This adds a level of engagement and excitement to the community play aspects of the game.

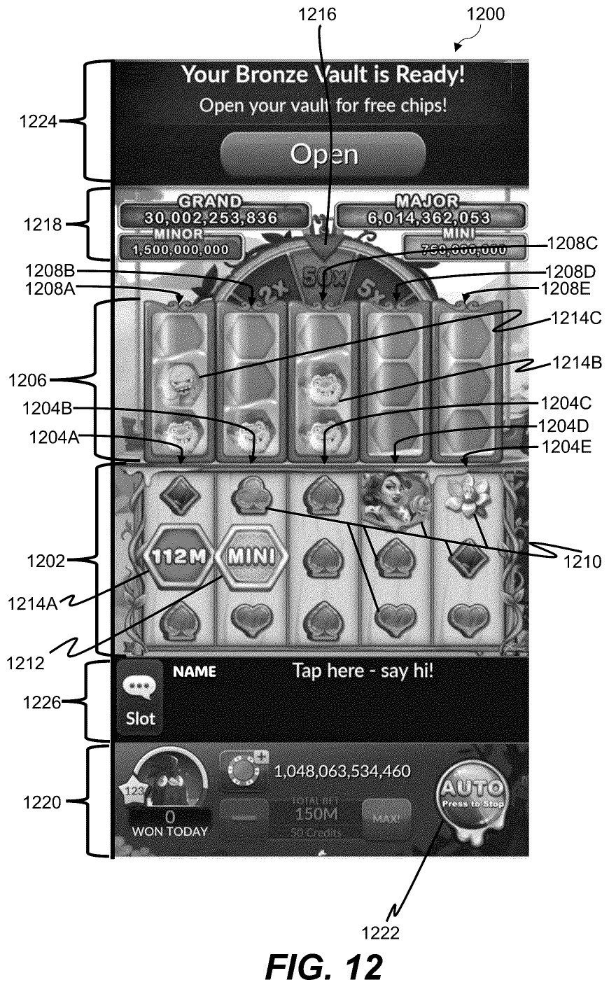

FIG. 12 illustrates an example interface 1200 of the base game of the mobile game. When viewed in sequence, interface 1200 may be treated as an interface that appears subsequent to interface 1100 shown in FIG. 11 during gameplay, or may be viewed in isolation. Interface 1200 is generally similar to interface 1100 but illustrates example implementations of various normal and social trigger symbols landing on the reel set.

FIG. 12 illustrates (i) a reel set 1202 the same as or similar to reel set 1102 shown in FIG. 11, including a plurality of reel columns 1204A, 1204B, 1204C, 1204D, and 1204E, and (ii) a community board 1206 the same as or similar to community board 1106 shown in FIG. 11, including a plurality of community board columns 1208A, 1208B, 1208C, 1208D, 1208E. Reels columns 1204A to 1204E may initially include various standard symbols 1210, a jackpot symbol 1212 (e.g., for the “MINI” jackpot), and a normal trigger symbol 1214A. Normal trigger symbol 1214A may have a certain value, such as 112M as shown in FIG. 12. Community board 1206 may be populated with community social trigger symbols 1214B and 1214C of players whose spins in the base game have triggered contributions of corresponding symbols to community board 1206 as described herein. For example, the landing of normal trigger symbol 1214A in column 1204A of reel set 1202 may trigger a corresponding community social trigger symbol to populate in the matching column (e.g., 1208A) if normal trigger symbol 1214A is upgraded to a social trigger symbol in the manner shown in and described in connection with FIGS. 5A and 5B. Such a social trigger symbol resulting from an upgraded normal trigger symbol and then represented by a community social trigger symbol in column 1208A will be attributed to the player that landed normal trigger symbol 1214A in column 1204A, and be represented in column 1208A by a corresponding symbol such as community social trigger symbols 1214B or 1214C (or the symbol of some other contributing player that landed normal trigger symbol 1214A and thus contributed a symbol to community board 1206 at column 1208A).

Interface 1200 also includes a multiplier wheel 1216 which is the same as or similar to wheel 1116 shown in FIG. 11, and a jackpot indicator section 1218 which is the same as or similar to jackpot indicator section 1118 shown in FIG. 11, for indicating various jackpot types and their values (e.g., Grand, Major, Minor, Mini). Another portion such as a lower portion of interface 1200 may include user interface elements 1220 such as a spin button 1222, as well as player profile information (e.g., profile picture, (e.g., total) amount won), a bet amount (with options to increase or decrease), a chat feature, etc. Compared to spin button 1122 in FIG. 11, spin button 1222 is in an “AUTO” spin state, which may be stopped if spin button 1222 is held (e.g., pressed) for a certain amount of time by a player so that spin button 1222 reverts to a single spin button function such as shown by spin button 1122 shown in FIG. 11. Interface 1200 may also include indicator portion 1224 that may provide player alerts and/or indicate a status of a feature that may award free items to players, such as free plays or free chips. A chat feature 1226 may be utilized in a portion such as a lower portion of interface 1200 that may enable players to chat with one another. Each of reel set 1202 and community board 1206 may be configured with a certain amount of rows and columns, for example in a 3×5 configuration with three rows and five columns, with the columns aligned as shown by columns 1204A-1204E and columns 1208A-1208E in FIG. 12. This is non-limiting and other configurations (e.g., 4×5, etc.) may be used).

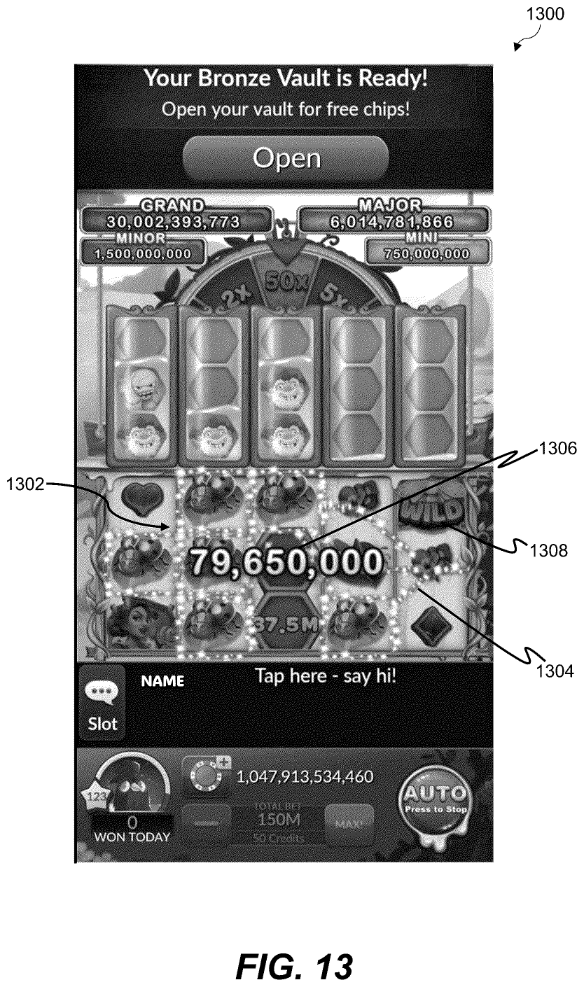

FIG. 13 illustrates an example interface 1300 of the base game of the mobile game, and is generally the same as or similar to interfaces 1100 and 1220 shown in FIGS. 11 and 12, respectively, and as such certain common elements such as the reels and the like are not described in detail in connection with FIG. 13. FIG. 13 illustrates example visual graphics 1302 that may appear based on if winning combinations of (e.g., standard) symbols appear on the reels, where graphics 1302 may include highlight lines 1304 drawn around and/or connecting certain symbols on the reels as well as a number amount 1306 representing an amount won. The amount won may be based on rules of the game and/or provided in a look-up table regarding valuations of certain winning combinations of (e.g., standard) symbols). FIG. 13 also illustrates a wild symbol 1308 that may land as part of the standard symbols (e.g., 420 shown in FIG. 4), which may land based on an RNG call such as by RNG 212. For example, graphics 1302 may be representative of a lines game of the base game as described herein. Additionally, as shown in FIG. 13, other symbols that are present on the reels but that are not part of the winning combination may be displayed in a darkened (e.g., grayed-out) state to provide improved visual notice to a player as to which symbols did/did not trigger the win. When viewed in sequence, interface 1300 may be an interface that appears subsequent to interface 1200 shown in FIG. 12 during gameplay, or may be viewed in isolation.

FIGS. 14A, 14B, and 14C illustrate example interfaces 1400A, 1400B, 1400C, respectively, of the base game of the mobile game, and in particular aspects of a boost feature of the mobile game that is the same as or similar to that shown in and described in connection with FIGS. 5A and 5B. Interfaces 1400A/1400B/1400C are generally the same as or similar to interfaces 1100, 1200, and 1300 shown in FIGS. 11, 12, and 13, respectively, and as such certain common elements such as the reels and the like are not described in detail in connection with FIGS. 14A to 14C. When viewed sequentially, interfaces 1400A/1400B/1400C illustrate how a boost symbol upgrades certain other symbols such as normal trigger symbols. FIG. 14A shows interface 1400A including a normal trigger symbol 1402A and a boost symbol 1404A having landed in different columns of the reel set of the base game. Boost symbol 1404A is an embodiment, for example, of boost symbol 506 shown in FIGS. 5A and 5B, and normal trigger symbol 1404A is similar to other normal trigger symbols described herein, such as normal trigger symbol 1214A shown in FIG. 12. FIG. 14A shows an initial state of normal trigger symbol 1402A, in that normal trigger symbol 1402A has not yet been upgraded by boost symbol 1404A.

FIG. 14B illustrates an interface 1400B which shows an intermediate state of boosting a normal trigger symbol by a boost symbol, where normal trigger symbol 1402A from FIG. 14A is in the process of transitioning its appearance (and value) to a boosted state by virtue of boost symbol 1404A. As shown in FIG. 14B, intermediate normal trigger symbol 1402B is in the process of changing appearance from being boosted by intermediate boost symbol 1404B, and intermediate boost symbol 1404B is shown with exaggerated “BOOST” graphics (e.g., larger text as compared to that in symbol 1404A in FIG. 14A). For example, the graphics used in interface 1400B include intermediate normal trigger symbol 1402B in a converted color, which may reflect a color scheme related to a theme of the game (which in this case may reflect a yellow color by virtue of normal trigger symbol 1402A as shown in FIG. 14 being covered in honey as part of being boosted).

FIG. 14C illustrates an interface 1400C which shows a boosted normal trigger symbol 1402C which has been boosted to a social trigger symbol and a boost symbol 1404C that has essentially reverted to boost symbol 1404A since its boost function has been expended. Boosted normal trigger symbol 1404C (also referred to as social trigger symbol 1402C) has completed the transition from normal trigger symbol 1402A as shown in FIG. 14A to social trigger symbol 1402C that has a different appearance and value as compared to normal trigger symbol 1402A, such as a honey-covered appearance and a boosted value (e.g., 412M compared to 337M as shown in FIG. 14A). Social trigger symbol 1402C may trigger addition of a community social trigger symbol to the corresponding column of the community board (e.g., the column of the community board directly above the column of the base game reel set in which the social trigger symbol is present) as illustrated by arrow 1406, which is similar to arrows 426, 614, and 714 as shown in and described in connection with FIGS. 4, 6, and 7, respectively.

FIGS. 15A, 15B, and 15C illustrate example interfaces 1500A/1500B/1500C of a bonus game of the base game of the mobile game, including example interfaces showing an interface of the triggered bonus game resulting from when a column of the community board is fully populated (e.g., three social trigger symbols populate any given column of the community board). The bonus game may be a wheel bonus utilizing a wheel that is the same as or similar to the multiplier wheel shown in FIG. 8, for example. FIGS. 15A-15C illustrate an embodiment of the bonus game aspects shown in and described in connection with FIG. 9. As shown in and described in connection with FIG. 9, the bonus game of the base game may feature a multiplier wheel that multiplies certain winning amounts by different multiples that are present on the multiplier wheel. The underlying (e.g., darkened) portions shown in interfaces 1500A/1500B/1500C are similar to (e.g., base game) interfaces 1400A/1400B/1400C shown in FIGS. 14A/14B/14C, respectively, and as such certain common elements such as the reels and the like are not described in detail in connection with FIGS. 15A to 15C. The darkened portions which darken the underlying base game may serve to visually emphasize the bonus game while de-emphasizing the underlying interface of the base game, which may be being played by other players in the background while the bonus game is being played. That is, the base game may still be actively being played by other players that are not part of the bonus game concurrent with the players that are playing the bonus game. In some embodiments, only the players that contributed to the full column in the community board, thereby triggering the bonus game, may see the bonus game interface, whereas the other players continue their play of the base game, which may take place in the darkened portions underneath the interfaces shown in FIGS. 15A-15C. Put another way, the interface of the bonus game overlays the underlying base game. When viewed sequentially, interfaces 1500A/1500B/1500C illustrate how the bonus game operates, such as awarding a social trigger symbol present in the column that triggered the bonus game with an increased value relative to whatever the value of that same social trigger symbol was upon triggering the bonus game.

Interface 1500A of FIG. 15A shows a triggering of a wheel-based bonus game after a column 1502 of community board 1504 is fully populated with social trigger symbols, where one or more of the social trigger symbols such as community social trigger symbol 1506A may have a certain defined value (e.g., 412M (412,000,000)). Full column 1502 of community board 1504 awards one or more plays of the wheel-based bonus game via multiplier wheel 1508 which may have a multiplier 1510 that lands when wheel 1508 stops spinning. Interface 1500A may also include a title graphic 1512 representing a name of the bonus game. The bonus game may have its own name which may match a theme of the name of the base game or some other theme of the base game, such as “Honeyfilled!”. While landed multiplier 1510 is shown as a 3× multiplier in the example shown in FIG. 15A, landed multiplier 1510 may be any one of the various multipliers provided on wheel 1508. As shown in FIGS. 15B and 15C, landed multiplier 1510 may increase an amount of a social trigger symbol such as community social trigger symbol 1506A by the multiple of landed multiplier 1510. While the bonus game is described as a wheel-based bonus game, this is just one example of a type of bonus game, and the wheel may be used in different ways and/or or no wheel may be used at all.

Interface 1500B of FIG. 15B shows awarding of wheel multiplier 1510 to community social trigger symbol 1506A such that the value of community social trigger symbol 1506A is increased to that shown for community social trigger symbol 1506B in FIG. 15B by virtue of the multiple of multiplier 1510. In the example shown in FIGS. 15A and 15B, multiplier 1510 is a 3× multiplier that upgrades the 412M value of community social trigger 1506A in shown in FIG. 15A to 1.23B for community social trigger symbol 1506B shown in FIG. 15B. Interface 1500B may also include an amount won graphic 1514 showing a total amount won in the bonus game. In the example shown in FIGS. 15A and 15B, this amount may be 1,237,500,000, reflective of the 1.23B amount of community social trigger symbol 1506B and any other potential winnings from the play of the bonus game.

Interface 1500C of FIG. 15C shows a win interface resulting from the conclusion of the bonus game. Title graphic 1512 as shown in FIGS. 15A and 15B may be replaced by a win graphic 1516 that may include terminology consistent with a theme of the base game and/or of the bonus game, such as “Sweet Win,” and may also include other graphics such as display of an amount won, similar to amount won graphic 1514 which shows 1,237,500,000. Additional visual graphics 1518, such as falling coins, may accompany win graphic 1516 to further celebrate the win in the bonus game.

After the bonus game ends, the player may be returned to the base game session (e.g., unless the player should choose to exit the session after the win). As described herein, the bonus game as shown in FIGS. 15A-15C and its corresponding interface including community board 1504 containing columns such as column 1502, wheel 1508, and graphics such as 1510, 1512, 1514, and 1516 that may be provided in an overlay manner relative to the base game, where the bonus game and its graphics are provided visually overtop the underlying base game interface at the same time the base game may be actively being played by other players, where at any given time any plurality of players may be in a bonus game sessions while others are in a base game session. Put another way, from a visual display standpoint, the underlying base game may be a base layer (or under layer) graphical display, and the bonus game and its graphics may be provided as overlay graphical display displayed over the underlying base game, while the base game may still be being played by other users not participating in the bonus game.

For bonus games, each player that contributed a social trigger symbol to a full column such as column 1502 may get a bonus game play, but in some embodiments graphics such as amount won graphic 1514 and win graphic 1516 may be individualized to each player of the bonus game even if the players of the bonus game all contributed to the same column such as column 1502. In other embodiments the contributing players may see the same bonus game interfaces. More generally, the bonus game interfaces 1500A/1500B/1500C may be individualized in a variety of ways for each participant in the bonus game. In some other embodiments, interfaces 1500A/1500B/1500C may generally be similar for each contributing player, and they may all win the same amount as a result of the bonus game, such that amount won graphic 1514 and win graphic 1516 may be the same or similar for the contributing players. In some embodiments, the only players that will see the bonus game interface and its graphics are the players that contributed to a column such as column 1502 that when filled triggers the bonus game. The non-contributing players may remain in the base game and do not see the bonus game and its graphics being played by the contributing players to a bonus game triggering column such as full column 1502. In the context of the bonus game, community social trigger symbols 1506A, 1506B may be considered to be scatter symbols as described herein, in that landing a full column of community social trigger symbols in the community board 1504 triggers the bonus game.

FIGS. 16A, 16B, 16C, 16D, and 16E illustrate example interfaces 1600A/1600B/1600C/1600D/1600E of an example secondary (e.g., feature) game that can be triggered from the base game. FIGS. 16A-16E may be viewed as being a sequence, in that FIG. 16A illustrates a first screen or interface of the sequence, and FIGS. 16B-16E illustrate subsequent sequential screens or interfaces within the feature game. The feature game may have a name that is consistent with a theme of the mobile game (e.g., such as “Sticky Spree”), and may be triggered/awarded by landing a certain amount of CORs, such as six or more CORs, in a single spin during play of the base game, where the CORs may include boost symbols as shown in and described in connection with FIGS. 5A, 5B, and 14A-14C (although the boost symbol is not carried into a hold & spin feature, as described herein). Such landing of six or more CORs in a single spin may be based on the results of an RNG call such as by RNG 212, and may be referred to herein as a feature game trigger event. In the case where both the bonus game (e.g., shown in and described in connection with FIGS. 15A-15C) and the feature game are awarded, the bonus game may be played first. If a hold & spin feature is triggered with a social trigger symbol, it may be replaced with a different COR symbol such as a normal trigger symbol upon entering the hold & spin feature. The social trigger symbol may still land in the feature game and the reel set and the community board of the feature game may function the same as or similar to the reel set and community board in the base game (e.g., as shown in and described in connection with FIGS. 11A, 12, 13 and 14A-14C). A boost symbol such as shown in and described in connection with FIGS. 5A, 5B, and 14A-14C may also land in the hold & spin feature. In some embodiments, boost spins may occur after its boost functionality is complete. For example, once a normal trigger symbol is converted into a social trigger symbol as described herein, the social trigger symbol is “collected” in a corresponding column of the community board by depositing a corresponding community social trigger symbol, and the social trigger symbol on the reel set may be converted into a normal trigger symbol. There may be other limits set in place, such as there only one boost symbol landing per spin that may be permitted according to rules of the game.

FIG. 16A illustrates normal trigger symbols 1602A, community board 1606A, and reel set 1608A. In the embodiment shown in FIG. 16A, six normal trigger symbols 1602A have landed on reel set 1608A of the base game, thereby triggering the feature game. The number of normal trigger symbols that trigger the feature game may be set in accordance with rules of the game or other rules/regulations as described herein, and the use of six symbols is only an example. The landing of the normal trigger symbols may be by virtue of an RNG call such as RNG 212. FIG. 16A shows that of the six normal trigger symbols 1602A, five of the normal trigger symbols have various values (e.g., 150M, 225M, 187M, 150M, 337M) and one of the normal trigger symbols is a jackpot COR symbol for the “MAJOR” jackpot, for example. Community board 1606A is populated with community social trigger symbols 1604A representing prior-landed (or prior-upgraded) social trigger symbols on reel set 1608A. Interface 1600A also illustrates a plurality of standard symbols 1610A, which may include symbols such as hearts, clubs, and spades (and diamonds, as shown by standard symbols 1110 in FIG. 11A), and/or other symbols that may relate to a theme of the game. For example, consistent with the general honey theme embodiment described herein, standard symbols 1610A may include flowers, bees, other insects such as ladybugs, honeycombs, a “queen”-type character representing a “queen bee”, and the like, as well as wild symbols that may have similar theming.

FIG. 16B illustrates interface 1600B including feature game graphics 1612 of the feature game. Feature game graphics 1612 may include a logo or other graphics and words associated with the feature game, such as a logo or graphics/words that are consistent with a theme of the feature game and/or the base game. In the example shown in FIG. 16B, feature graphics 1612 may include graphics such as bees, honey, and the words “Sticky Spree” in connection with interface 1600B introducing the start of the feature game to the player. Feature game graphics 1612 may be temporarily overlaid on top of the reel set and community board as shown in interface 1600A while the base game is transitioning to the feature game and/or the feature game is being loaded. The underlying interface may therefore be displayed in a darkened manner to emphasize feature game graphics 1612 and/or de-emphasize the underlying interface while the feature game is readying.

FIG. 16C illustrates playing of the feature game, which may include normal trigger symbols 1602C in reel set 1608C and community social trigger symbols 1604C in community board 1606C, which have been carried over from reel set 1608A and community board 1606A shown in FIG. 16A (e.g., the various COR symbols on the reel set and the symbols on the community board are the same in FIG. 16A and FIG. 16C). However, while standard (e.g., non-COR) symbols 1610A shown in reel set 1608A may be displayed as standard symbols 1610C in reel set 1608C, as shown by the darkened appearance of the locations of standard symbols 1610C, standard symbols 1610C are not active as are normal trigger symbols 1602C. This inactivity of standard symbols 1610C represents an embodiment of a hold & spin function as described herein, where the normal trigger symbols 1602C are held in place, while standard symbols 1610C are not. When a spin of the feature game occurs, the locations occupied by standard symbols 1610C may generate new symbols. As such, normal trigger symbols 1602C are held in place, whereas the reels of reel set 1608C where standard symbols 1610C are present will spin and land a new set(s) of symbols, which may include standard symbols such as CORs. Interface 1600C may also include a feature game free spin indicator 1614 that displays a fixed amount of spins (e.g., free spins) of the feature game, where the feature game continues as long as spins are available. Each spin may land one or more CORs (or no CORs) until the spins are exhausted, such as normal trigger symbols and/or jackpot CORs. Certain CORs that land may trigger additional spins to be awarded to prolong the feature game. Interface 1600C may further include jackpot indicators 1616 showing a value of the various jackpots such as “Grand,” “Major,” “Minor,” and “Mini” jackpots as described herein. For example, in FIG. 16C, the Major jackpot is 6,030,007,547, as an example of a potential value of such a jackpot.

FIG. 16D illustrates a result of a conclusion of a playing of the feature game, where reel set 1608D has landed different symbols compared to those shown in reel set 1608C of FIG. 16C, as part of certain symbols (e.g., 1602C) being held and the reels spinning for the other symbols (e.g., 1610C) as described herein. For example, while symbols 1602D (e.g., COR symbols) remain the same as symbols 1602C, standard symbols 1610D are not the same as symbols 1610C (unless the same symbol happened to randomly land during free spins of the bonus game). To further illustrate this aspect, from a comparison of FIGS. 16C and 16D, it is apparent that reel set 1608D has more normal trigger symbols than reel set 1608C in FIG. 16C, representing that additional normal trigger symbols other than the six normal trigger symbols 1602C shown in FIG. 16C (e.g., that were inherited from landing symbols 1602A in FIG. 16A) landed during play of the feature game. As a result of the feature game, the player may have won the jackpot prize such as the “Major” jackpot prize due to having landed a jackpot COR symbol as shown in FIGS. 16A and 16C. Interface 1600D may include a jackpot graphic 1618 that may be displayed to the player to indicate their winning of the jackpot prize. Jackpot prize graphic 1618 may indicate the name and value of the jackpot won. For example, as shown in FIG. 16D, jackpot prize graphic 1618 indicates the “Major” jackpot was won and valued at 6,030,007,457, as described herein, such as in connection with FIG. 16C. Interface 1600D may further include a feature game amount won graphic 1620, which may display an amount won from the playing of the feature game. For example, feature game amount won graphic 1620 as shown in FIG. 16D may show 1,987,500,000, which may be reflective of the various symbols that landed during the free spins of the free game. The graphics (e.g., 1618, 1620) may be provided as an overlay in the same or similar manner as described herein, such as in connection with FIGS. 15A-15C.

FIG. 16E illustrates a feature game prize graphic 1622 that may appear after the feature game has concluded and the total amount won during the feature game has been tallied. Feature game prize graphic 1622 may show the total amount won from the feature game along with visual graphics 1624 such as falling coins to celebrate the win. The total shown in feature game prize graphic 1622 may be based on the sum of the amounts won during the feature game, such as any jackpot won as well as any amount won from the value of each COR symbol that landed on the reel set of the feature game. For example, as shown in FIG. 16E, feature game prize graphic 1622 may indicate a value such as 8,355,007,547, which approximates the sum of the jackpot winnings (6,030,007,547) and reel winnings (1,987,500,00) shown in and as described herein in connection with FIG. 16D, plus any ancillary winnings resulting from other play aspects of the feature game. The feature game and its graphics (e.g., 1622, 1624) may be provided as an overlay in the same or similar manner as described herein, such as in connection with FIGS. 15A-15C. Additionally, only the player that triggered the feature game may see the interfaces of FIGS. 16B-16E, while the other players not in a feature game may be playing the base game within the same game session. Once the feature game has ended, the player may be returned to the active base game session. For any reference herein to any screenshots or interfaces being in a sequence, there may be intervening screenshots and/or interfaces that are not shown, and as such the depictions of the sequences are not limiting and represent examples of portions of sequences that may be displayed in the game.

Additional aspects of the systems and methods described herein may include special cases and/or additional information or alterations, including but not limited to: (1) a popup message that may be displayed for any wins while a player is away (e.g., away on recovery); (2) some or all community board events may be queued and displayed on a first-in, first-out (FIFO) basis (e.g., community board events may take priority over spin events); (3) some or all community board events in a game session (e.g., on the table) may be broadcast to some or all of the players in the game session (e.g., on the table) so that even if the player sits idle, the progress on the community board can still be seen and enjoyed by other players; (4) a reel interface configuration (3×5) may be varied to other configurations (e.g., 4×5, etc.); (5) an orientation of the interfaces shown in FIGS. 4-16E may include portrait or landscape; (6) jackpots may include one or more of Mini, Minor, Major, and Grand.

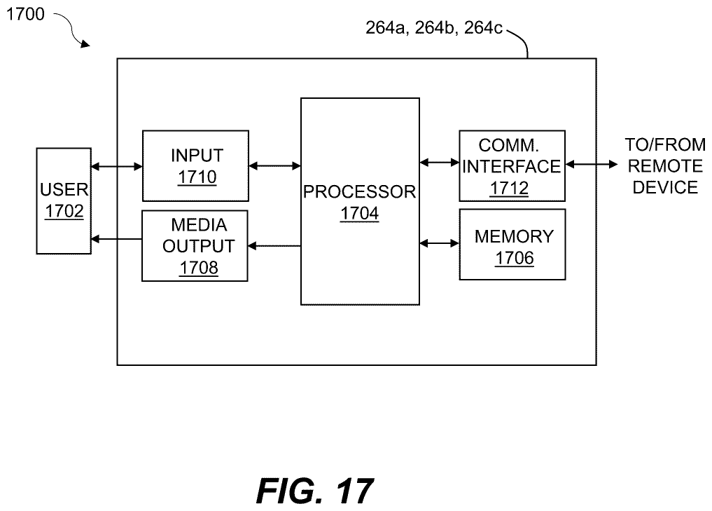

FIG. 17 illustrates an example configuration 1700 of personal computing devices such as EUDs 264a, 264b and 264c that a user (e.g., player) 1702 may use to play the electronic game, where user 1702 may be the same as or similar to users 274a-274c. Each EUD 264a, 264b, and 264c includes a processor 1704 operatively coupled with a memory 1706. Each EUD 264a, 264b and 264c also includes at least one media output component 1708 for presenting information to user 1702. In some embodiments, media output component 1708 includes an output adapter such as a video adapter and/or an audio adapter. An output adapter is operatively coupled to processor 1704 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, each EUD 264a, 264b and 264c includes an input device 1710 for receiving input from user 1702. Input device 1710 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 1708 and input device 1710. Each EUD 264a, 264b and 264c further includes a communication interface 1712 so that each EUD 264a, 264b and 264c may communicate with other computing devices (e.g., remote devices) within the system(s) shown and/or referenced in FIGS. 1, 2A, 2B, 2C, 3.

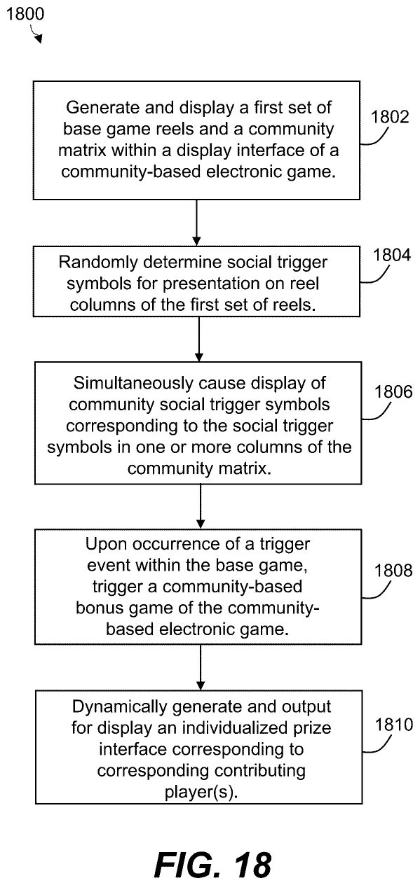

FIG. 18 illustrates an example method 1800 for providing the electronic game shown, for example, in FIGS. 10-13, 14A-14C, 15A-15C, and 16A-16E. Step 1802 includes generating and displaying, as part of a base game of the community-based electronic game, a first set of reels (e.g., the same as or similar to reel sets 408, 608, 708, 1102, 1202, 1608A) and a community board (e.g., the same as or similar to community board/matrix 406, 606, 706, 906, 1106, 1206) within a display interface of the community-based electronic game. Step 1804 includes randomly determining one or more social trigger symbols (e.g., the same as or similar to social trigger symbols 402A, 502, 602A, 702A, 1402C) for presentation on one or more reel columns of the first set of reels. Step 1806 includes simultaneously causing display of one or more community social trigger symbols (e.g., the same as or similar to community social trigger symbols 402B, 602B, 702B, 902, 1112, 1114, 1214B, 1214C) that correspond to the one or more social trigger symbols presented on the one or more reel columns of the first set of reels in one or more columns of the community board, each of the one or more columns of the community board aligning and being associated with a corresponding respective reel column of the one or more columns of the first set of reels. Step 1808 includes, upon occurrence of a trigger event within the base game, triggering a community-based bonus game (such as shown in FIGS. 15A-15C) of the community-based electronic game, the community-based bonus game utilizing a triggering column population (e.g., 1502) from the community board (e.g., 1504) of the base game that triggered the trigger event to determine an award of one or more prizes resulting from playing of the community-based bonus game, the triggering column population from the community board of the base game including one or more contributed community social trigger symbols (e.g., 1506A, 1506B) contributed by playing of the base game by one or more players of the base game. Step 1810 includes dynamically generating and outputting for display an individualized prize interface (e.g., shown in FIG. 15C) corresponding to the one or more prizes to each of the one or more players of the base game whose play provided the one or more contributed community social trigger symbols to the population of the triggering column population.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device for providing a community-based electronic game including a community matrix for providing community gameplay of the community-based electronic game, comprising:
at least one memory device with instructions stored thereon; and
at least one processor in communication with the at least one memory device, wherein the instructions, when executed by the at least one processor, cause the at least one processor to:
generate and display, as part of a base game of the community-based electronic game, a first set of reels and the community matrix within a display interface of the community-based electronic game;
randomly determine one or more social trigger symbols to be presented on one or more reel columns of the first set of reels, the one or more social trigger symbols being associated with a plurality of players of the community-based electronic game playing in a same session of the community-based electronic game as one another; and
for each of the one or more social trigger symbols presented on the one or more reel columns of the first set of reels, simultaneously cause one or more community social trigger symbols to be presented on one or more columns of the community matrix, each of the one or more columns of the community matrix aligning with and being associated with a corresponding respective reel column of the one or more columns of the first set of reels, and each of the one or more community social trigger symbols being attributed to respective one or more players of the plurality of players whose play in the base game resulted in at least one social trigger symbol of the one or more social trigger symbols to be presented on the one or more columns of the first set of reels.

2. The electronic gaming device of claim 1, wherein the community-based electronic game includes a bonus game that includes a multiplier wheel that includes a plurality of multiplier values.

3. The electronic gaming device of claim 2, wherein upon at least one column of the one or more columns of the community matrix being filled with a pre-determined amount of community social trigger symbols, the instructions, when executed by the at least one processor, further cause the at least one processor to trigger the bonus game for play by the respective one or more players of the plurality of players whose play in the base game resulted in the at least one column of the one or more columns of the community matrix being filled.

4. The electronic gaming device of claim 3, wherein the instructions, when executed by the at least one processor, further cause the at least one processor to spin the multiplier wheel and apply a multiplier value of the plurality of multiplier values that results from the spin to an amount won in association with the filled at least one column of the one or more columns of the community matrix.

5. The electronic gaming device of claim 4, wherein the instructions, when executed by the at least one processor, further cause the at least one processor to dynamically generate and output for display on one or more end user device associated with the respective one or more players of the bonus game a prize interface corresponding to one or more prizes awarded to each of the respective one or more players of the bonus game.

6. The electronic gaming device of claim 5, wherein other players of the plurality of players continue to play the base game while the respective one or more players play the bonus game, and the prize interface is not displayed on end user devices of the other players.

7. The electronic gaming device of claim 1, wherein an amount of the one or more reel columns of the first set of reels is the same as an amount of the one or more columns of the community matrix.

8. The electronic gaming device of claim 7, wherein the one or more columns of the community matrix are presented immediately above the one or more reel columns of the first set of reels within the display interface.

9. The electronic gaming device of claim 1, wherein the instructions, when executed by the at least one processor, cause the at least one processor to randomly determine one or more normal trigger symbols to be presented on the one or more reel columns of the first set of reels.

10. The electronic gaming device of claim 9, wherein the instructions, when executed by the at least one processor, cause the at least one processor to:
randomly determine one or more boost symbols to be presented on the one or more reel columns of the first set of reels;
upgrade, via at least one of the one or more boost symbols, at least one of the one or more normal trigger symbols to a social trigger symbol; and
cause a community social trigger symbol corresponding to the social trigger symbol resulting from the upgraded at least one of the one or more normal trigger symbols to be presented on a column of the one or more columns of the community matrix.

11. The electronic gaming device of claim 9, wherein the community-based electronic game includes a feature game, and upon a pre-determined amount of the one or more normal trigger symbols being presented on the one or more reel columns of the first set of reels, the instructions, when executed by the at least one processor, cause the at least one processor to trigger the feature game for play by a respective player of the plurality of players whose play in the base game caused the pre-determined amount of the one or more normal trigger symbols to be presented on the one or more reel columns of the first set of reels.

12. The electronic gaming device of claim 11, wherein other players of the plurality of players continue to play the base game while the respective player plays the feature game.

13. The electronic gaming device of claim 1, wherein the one or more community social trigger symbols being attributed to respective one or more players of the plurality of players includes displaying, as part of a display of the one or more community social trigger symbols, a graphic associated with the particular player that caused the one or more community social trigger symbols to be presented.

14. A computer-implemented method for providing a community-based electronic game implemented using at least one processor in communication with at least one memory, the method comprising:
generating and displaying, as part of a base game of the community-based electronic game, a first set of reels and a community matrix within a display interface of the community-based electronic game;
randomly determining one or more social trigger symbols to be presented on one or more reel columns of the first set of reels, the one or more social trigger symbols being associated with a plurality of players of the community-based electronic game playing in a same session of the community-based electronic game as one another; and
for each of the one or more social trigger symbols presented on the one or more reel columns of the first set of reels, simultaneously causing one or more community social trigger symbols to be presented on one or more columns of the community matrix, each of the one or more columns of the community matrix aligning with and being associated with a corresponding respective reel column of the one or more columns of the first set of reels, and each of the one or more community social trigger symbols being attributed to respective one or more players of the plurality of players whose play in the base game resulted in at least one social trigger symbol of the one or more social trigger symbols to be presented on the one or more columns of the first set of reels.

15. The computer-implemented method of claim 14, wherein the community-based electronic game includes a bonus game that includes a multiplier wheel that includes a plurality of multiplier values, and upon at least one column of the one or more columns of the community matrix being filled with a pre-determined amount of community social trigger symbols, the method further comprising triggering the bonus game for play by the respective one or more players of the plurality of players whose play in the base game resulted in the at least one column of the one or more columns of the community matrix being filled.

16. The computer-implemented method of claim 14, further comprising determining one or more normal trigger symbols to be presented on the one or more reel columns of the first set of reels.

17. The computer-implemented method of claim 16, further comprising:
randomly determining one or more boost symbols to be presented on the one or more reel columns of the first set of reels;
upgrading, via at least one of the one or more boost symbols, at least one of the one or more normal trigger symbols to a social trigger symbol; and
causing a community social trigger symbol corresponding to the social trigger symbol resulting from the upgraded at least one of the one or more normal trigger symbols to be presented on a column of the one or more columns of the community matrix.

18. One or more non-transitory computer-readable storage media with instructions stored thereon that, in response to being executed, cause an electronic gaming device to:
generate and display, as part of a base game of a community-based electronic game, a first set of reels and a community matrix within a display interface of the community-based electronic game;
randomly determine one or more social trigger symbols to be presented on one or more reel columns of the first set of reels, the one or more social trigger symbols being associated with a plurality of players of the community-based electronic game playing in a same session of the community-based electronic game as one another; and
for each of the one or more social trigger symbols presented on the one or more reel columns of the first set of reels, simultaneously cause one or more community social trigger symbols to be presented on one or more columns of the community matrix, each of the one or more columns of the community matrix aligning with and being associated with a corresponding respective reel column of the one or more columns of the first set of reels, and each of the one or more community social trigger symbols being attributed to respective one or more players of the plurality of players whose play in the base game resulted in at least one social trigger symbol of the one or more social trigger symbols to be presented on the one or more columns of the first set of reels.

19. The one or more non-transitory computer-readable storage media of claim 18, wherein the instructions, in response to being executed, further cause the electronic gaming device to randomly determine one or more normal trigger symbols to be presented on the one or more reel columns of the first set of reels.

20. The one or more non-transitory computer-readable storage media of claim 19, wherein the instructions, in response to being executed, further cause the electronic gaming device to:
randomly determine one or more boost symbols to be presented on the one or more reel columns of the first set of reels;
upgrade, via at least one of the one or more boost symbols, at least one of the one or more normal trigger symbols to a social trigger symbol; and
cause a community social trigger symbol corresponding to the social trigger symbol resulting from the upgraded at least one of the one or more normal trigger symbols to be presented on a column of the one or more columns of the community matrix.
